(19) United States
(12) Patent Application Publication
(10) Pub. No.: US 2025/0047543 A1
(43) Pub. Date: Feb. 6, 2025

(54) ORTHOGONAL TIME FREQUENCY SPACE MODULATION FOR PHYSICAL DOWNLINK CONTROL CHANNEL

(71) Applicant: QUALCOMM Incorporated, San Diego, CA (US)

(72) Inventors: Huilin XU, Temecula, CA (US); Jun MA, San Diego, CA (US); Mohamad SAYED HASSAN, Paris (FR); Qiang WU, San Diego, CA (US); Mehmet Izzet GURELLI, San Diego, CA (US); Yuwei REN, Beijing (CN); Weimin DUAN, San Diego, CA (US); Lianghai JI, San Diego, CA (US); Karthik ANANTHA SWAMY, La Jolla, CA (US)

(21) Appl. No.: 18/705,147

(22) PCT Filed: Jan. 20, 2022
(86) PCT No.: PCT/CN2022/072885

§ 371 Date: Apr. 26, 2024

(51) Int. Cl. H04L 27/26; H04L 5/00

(52) U.S. Cl. CPC H04L 27/26532; H04L 5/0094

(57) ABSTRACT

Various aspects of the present disclosure generally relate to wireless communication. In some aspects, a user equipment (UE) may receive, from a base station, a configuration of a control region in a delay-Doppler domain. The UE may receive, from the base station, a physical downlink control channel (PDCCH) communication with orthogonal time frequency space (OTFS) precoding. The UE may decode the PDCCH communication with OTFS precoding based at least in part on the configuration of the control region in the delay-Doppler domain. Numerous other aspects are described.

### FIELD OF THE DISCLOSURE

Aspects of the present disclosure generally relate to wireless communication and to techniques and apparatuses for orthogonal time frequency space (OTFS) modulation for physical downlink control channel (PDCCH) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a base station, a configuration of a control region in a delay-Doppler domain. The one or more processors may be configured to receive, from the base station, a physical downlink control channel (PDCCH) communication with orthogonal time frequency space (OTFS) precoding. The one or more processors may be configured to decode the PDCCH communication with OTFS precoding based at least in part on the configuration of the control region in the delay-Doppler domain.

Some aspects described herein relate to a base station for wireless communication. The base station may include a memory and one or more processors coupled to the memory. The one or more processors may be configured to transmit, to a UE, a configuration of a control region in a delay-Doppler domain. The one or more processors may be configured to apply OTFS precoding to a PDCCH communication included in the control region in the delay-Doppler domain. The one or more processors may be configured to transmit, to the UE, the PDCCH communication with OTFS precoding.

Some aspects described herein relate to a UE for wireless communication. The UE may include a memory and one or more processors coupled to the memory. The one or more processors may be configured to receive, from a base station, a first stage PDCCH communication without OTFS precoding, wherein the first stage PDCCH communication indicates whether a downlink communication with OTFS precoding is scheduled in an OTFS modulation block. The one or more processors may be configured to selectively buffer or not buffer time domain samples associated with the OTFS modulation block based at least in part on the first stage PDCCH communication.

Some aspects described herein relate to a base station for wireless communication. The base station may include a memory and one or more processors coupled to the memory. The one or more processors may be configured to transmit, to a UE, a first stage PDCCH communication without OTFS precoding, wherein the first stage PDCCH communication indicates whether a downlink communication with OTFS precoding is scheduled for the UE in an OTFS modulation block.

Some aspects described herein relate to a method of wireless communication performed by a UE. The method may include receiving, from a base station, a configuration of a control region in a delay-Doppler domain. The method may include receiving, from the base station, a PDCCH communication with OTFS precoding. The method may include decoding the PDCCH communication with OTFS precoding based at least in part on the configuration of the control region in the delay-Doppler domain.

Some aspects described herein relate to a method of wireless communication performed by a base station. The method may include transmitting, to a UE, a configuration of a control region in a delay-Doppler domain. The method may include applying OTFS precoding to a PDCCH communication included in the control region in the delay-Doppler domain. The method may include transmitting, to the UE, the PDCCH communication with OTFS precoding.

Some aspects described herein relate to a method of wireless communication performed by a UE. The method may include receiving, from a base station, a first stage PDCCH communication without OTFS precoding, wherein the first stage PDCCH communication indicates whether a downlink communication with OTFS precoding is scheduled in an OTFS modulation block. The method may include selectively buffering or not buffering time domain samples associated with the OTFS modulation block based at least in part on the first stage PDCCH communication.

Some aspects described herein relate to a method of wireless communication performed by a base station. The method may include transmitting, to a UE, a first stage PDCCH communication without OTFS precoding, wherein the first stage PDCCH communication indicates whether a downlink communication with OTFS precoding is scheduled for the UE in an OTFS modulation block.

Some aspects described herein relate to a non-transitory computer-readable medium that stores a set of instructions for wireless communication by a UE. The set of instructions, when executed by one or more processors of the UE, may cause the UE to receive, from a base station, a configuration of a control region in a delay-Doppler domain. The set of instructions, when executed by one or more processors of the UE, may cause the UE to receive, from the base station, a PDCCH communication with OTFS precoding. The set of instructions, when executed by one or more processors of the UE, may cause the UE to decode the PDCCH communication with OTFS precoding based at least in part on the configuration of the control region in the delay-Doppler domain.

Some aspects described herein relate to a non-transitory computer-readable medium that stores a set of instructions for wireless communication by a base station. The set of instructions, when executed by one or more processors of the base station, may cause the base station to transmit, to a UE, a configuration of a control region in a delay-Doppler domain. The set of instructions, when executed by one or more processors of the base station, may cause the base station to apply OTFS precoding to a PDCCH communication included in the control region in the delay-Doppler domain. The set of instructions, when executed by one or more processors of the base station, may cause the base station to transmit, to the UE, the PDCCH communication with OTFS precoding.

Some aspects described herein relate to a non-transitory computer-readable medium that that stores a set of instructions for wireless communication by a UE 120. The set of instructions, when executed by one or more processors of the UE, may cause the UE to receive, from a base station, a first stage PDCCH communication without OTFS precoding, wherein the first stage PDCCH communication indicates whether a downlink communication with OTFS precoding is scheduled in an OTFS modulation block. The set of instructions, when executed by one or more processors of the UE, may cause the UE to selectively buffer or not buffer time domain samples associated with the OTFS modulation block based at least in part on the first stage PDCCH communication.

Some aspects described herein relate to a non-transitory computer-readable medium that stores a set of instructions for wireless communication by a base station. The set of instructions, when executed by one or more processors of the base station, may cause the base station to transmit, to a UE, a first stage PDCCH communication without OTFS precoding, wherein the first stage PDCCH communication indicates whether a downlink communication with OTFS precoding is scheduled for the UE in an OTFS modulation block.

Some aspects described herein relate to an apparatus for wireless communication. The apparatus may include means for receiving, from a base station, a configuration of a control region in a delay-Doppler domain. The apparatus may include means for receiving, from the base station, a PDCCH communication with OTFS precoding. The apparatus may include means for decoding the PDCCH communication with OTFS precoding based at least in part on the configuration of the control region in the delay-Doppler domain.

Some aspects described herein relate to an apparatus for wireless communication. The apparatus may include means for transmitting, to a UE, a configuration of a control region in a delay-Doppler domain. The apparatus may include means for applying OTFS precoding to a PDCCH communication included in the control region in the delay-Doppler domain. The apparatus may include means for transmitting, to the UE, the PDCCH communication with OTFS precoding.

Some aspects described herein relate to an apparatus for wireless communication. The apparatus may include means for receiving, from a base station, a first stage PDCCH communication without OTFS precoding, wherein the first stage PDCCH communication indicates whether a downlink communication with OTFS precoding is scheduled in an OTFS modulation block. The apparatus may include means for selectively buffering or not buffering time domain samples associated with the OTFS modulation block based at least in part on the first stage PDCCH communication.

Some aspects described herein relate to an apparatus for wireless communication. The apparatus may include means for transmitting, to a UE, a first stage PDCCH communication without OTFS precoding, wherein the first stage PDCCH communication indicates whether a downlink communication with OTFS precoding is scheduled for the UE in an OTFS modulation block. The apparatus may include means for transmitting, to the UE, a second stage PDCCH communication with OTFS precoding, wherein the second stage PDCCH communication includes scheduling information for the downlink communication with OTFS precoding scheduled in the OTFS modulation block, wherein the second stage PDCCH communication with OTFS is included in the OTFS modulation block.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example resource structure for wireless communication, in accordance with the present disclosure.

FIGS. 5A and 5B are diagrams illustrating an example of orthogonal time frequency space (OTFS) based communication, in accordance with the present disclosure.

FIGS. 6-8 are diagrams illustrating examples associated with OTFS modulation for physical downlink control channel (PDCCH) communications, in accordance with the present disclosure.

FIGS. 9-12 are diagrams illustrating example processes associated with OTFS modulation for PDCCH communications, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

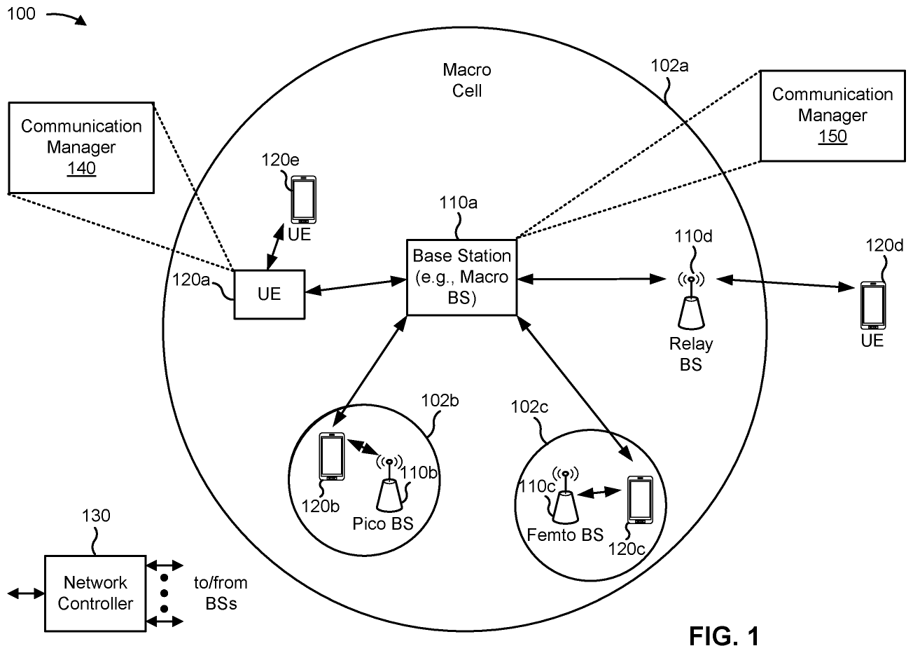

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station, a configuration of a control region in a delay-Doppler domain; receive, from the base station, a physical downlink control channel (PDCCH) communication with orthogonal time frequency space (OTFS) precoding; and decode the PDCCH communication with OTFS precoding based at least in part on the configuration of the control region in the delay-Doppler domain. Additionally, or alternatively, the communication manager 140 may perform one or more other operations described herein.

In some aspects, as described in more detail elsewhere herein, the communication manager 140 may receive, from a base station, a first stage PDCCH communication without OTFS precoding, wherein the first stage PDCCH communication indicates whether a downlink communication with OTFS precoding is scheduled in an OTFS modulation block; and selectively buffer or not buffer time domain samples associated with the OTFS modulation block based at least in part on the first stage PDCCH communication. Additionally, or alternatively, the communication manager 140 may perform one or more other operations described herein.

In some aspects, the base station 110 may include a communication manager 150. As described in more detail elsewhere herein, the communication manager 150 may transmit, to a UE, a configuration of a control region in a delay-Doppler domain; apply OTFS precoding to a PDCCH communication included in the control region in the delay-Doppler domain; and transmit, to the UE, the PDCCH communication with OTFS precoding. Additionally, or alternatively, the communication manager 150 may perform one or more other operations described herein.

In some aspects, as described in more detail elsewhere herein, the communication manager 150 may transmit, to a UE, a first stage PDCCH communication without OTFS precoding, wherein the first stage PDCCH communication indicates whether a downlink communication with OTFS precoding is scheduled for the UE in an OTFS modulation block. Additionally, or alternatively, the communication manager 150 may perform one or more other operations described herein.

As indicated above, FIG. 1 is provided as an example. Other examples may differ from what is described with regard to FIG. 1.

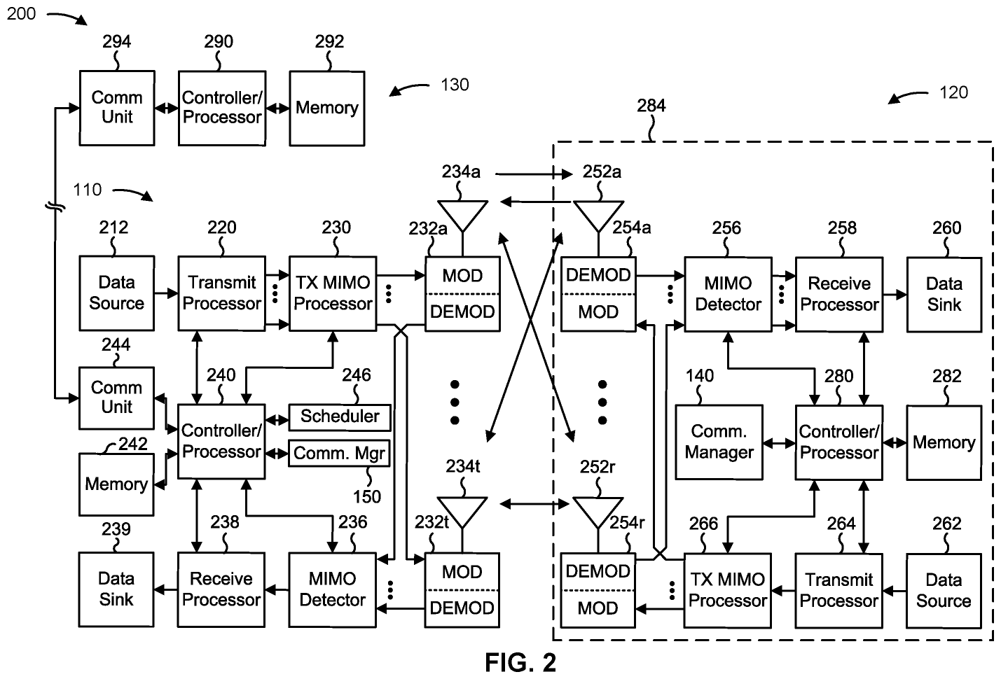

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

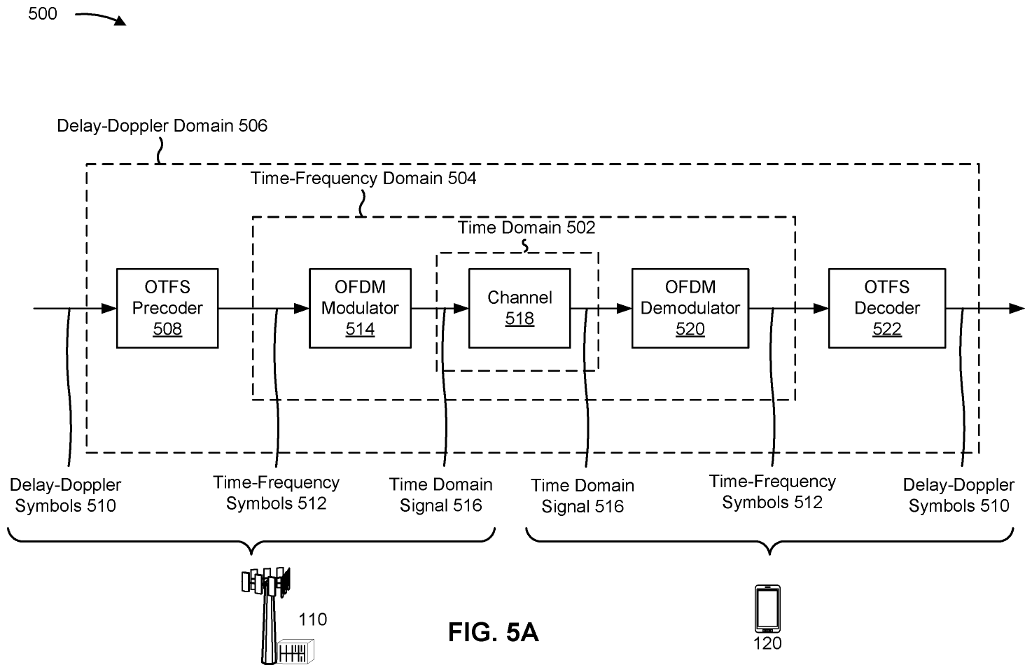

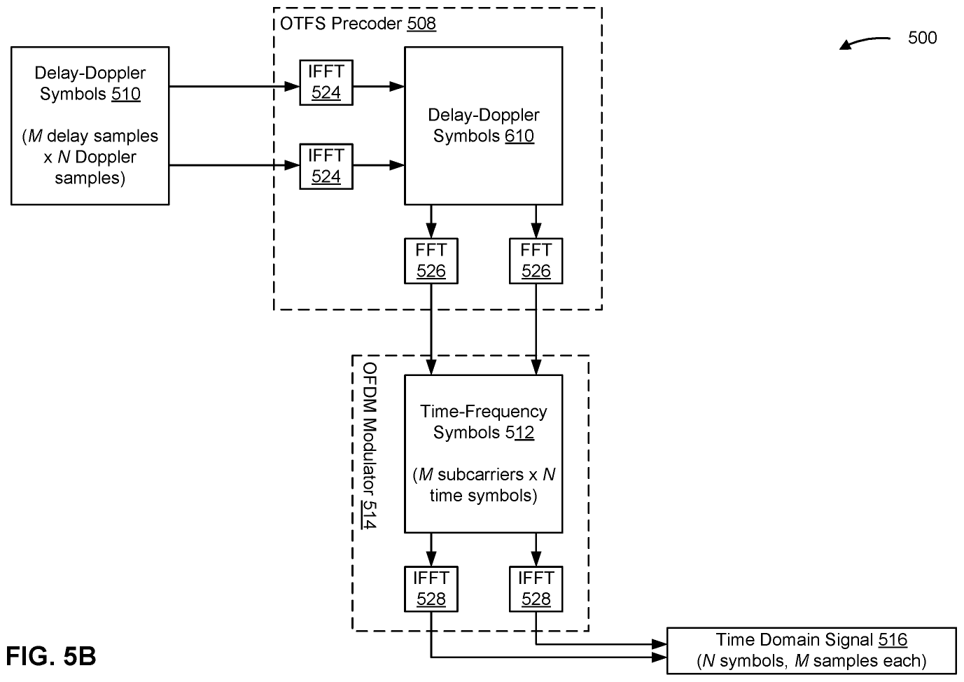

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A, 5B, and 6-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A, 5B, and 6-14).

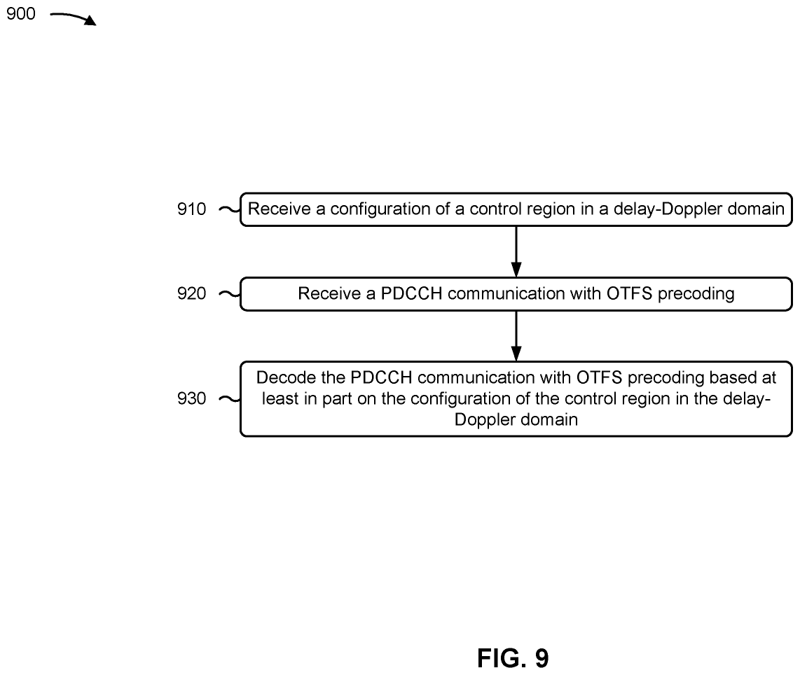

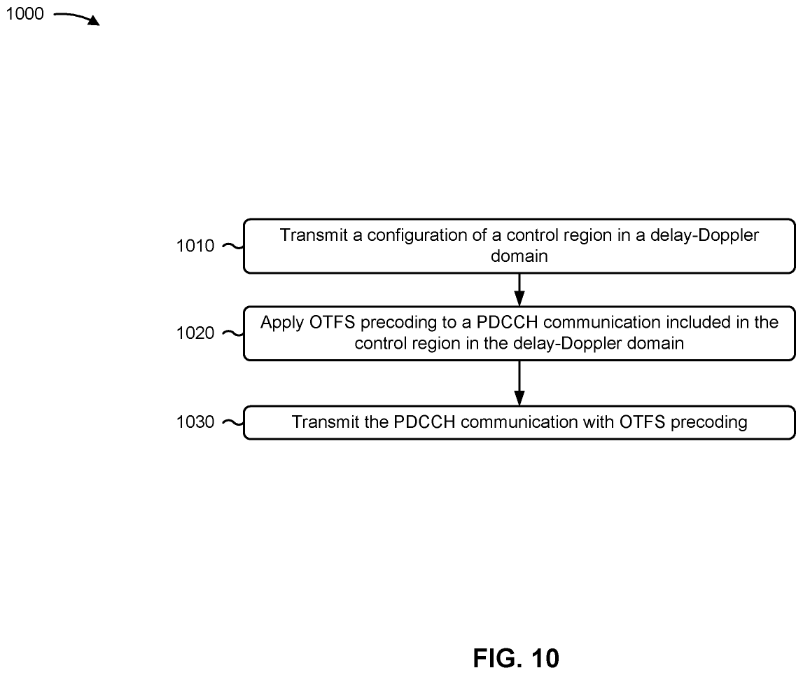

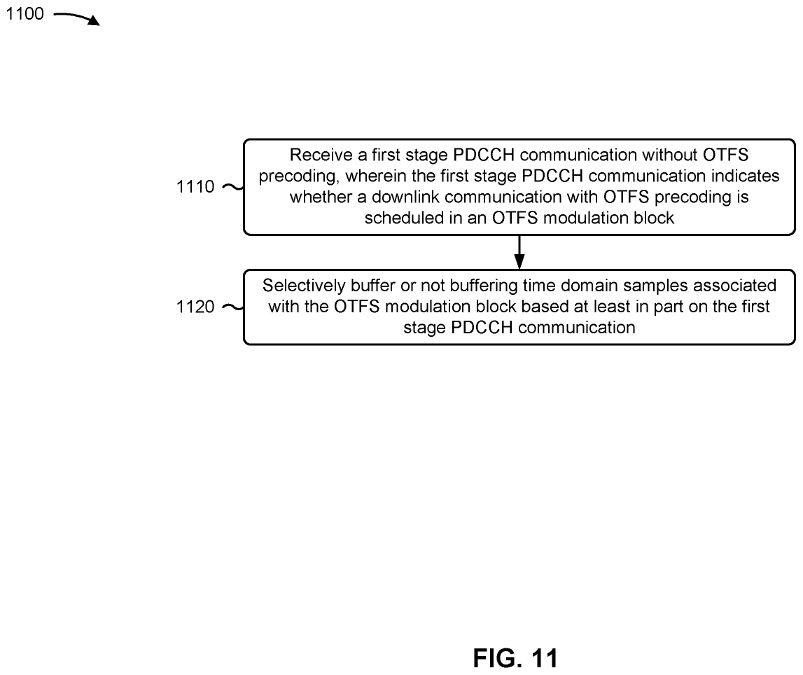

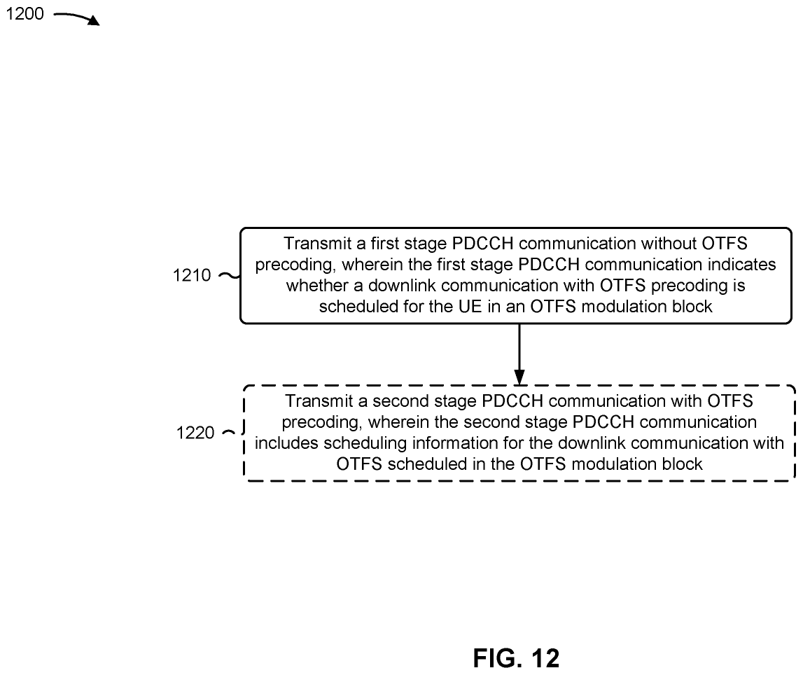

The controller/processor 240 of the base station 110, the controller/processor 280 of the UE 120, and/or any other component(s) of FIG. 2 may perform one or more techniques associated with OTFS modulation for PDCCH communications, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving, from a base station, a configuration of a control region in a delay-Doppler domain; means for receiving, from the base station, a PDCCH communication with OTFS precoding; and/or means for decoding the PDCCH communication with OTFS precoding based at least in part on the configuration of the control region in the delay-Doppler domain. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, a configuration of a control region in a delay-Doppler domain; means for applying OTFS precoding to a PDCCH communication included in the control region in the delay-Doppler domain; and/or means for transmitting, to the UE, the PDCCH communication with OTFS precoding. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving, from a base station, a first stage PDCCH communication without OTFS precoding, wherein the first stage PDCCH communication indicates whether a downlink communication with OTFS precoding is scheduled in an OTFS modulation block; and/or means for selectively buffering or not buffering time domain samples associated with the OTFS modulation block based at least in part on the first stage PDCCH communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, a first stage PDCCH communication without OTFS precoding, wherein the first stage PDCCH communication indicates whether a downlink communication with OTFS precoding is scheduled for the UE in an OTFS modulation block. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

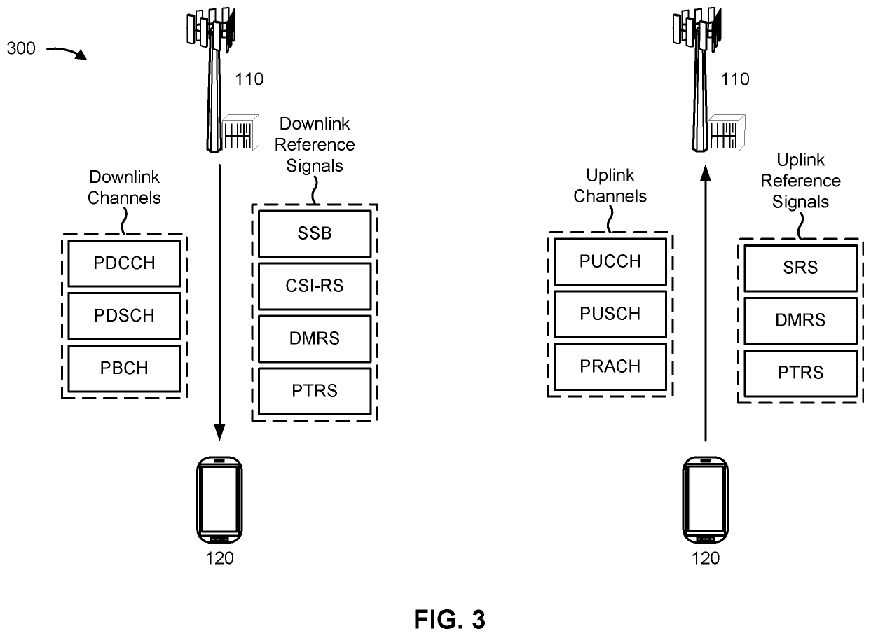

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a PDCCH that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the ULE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

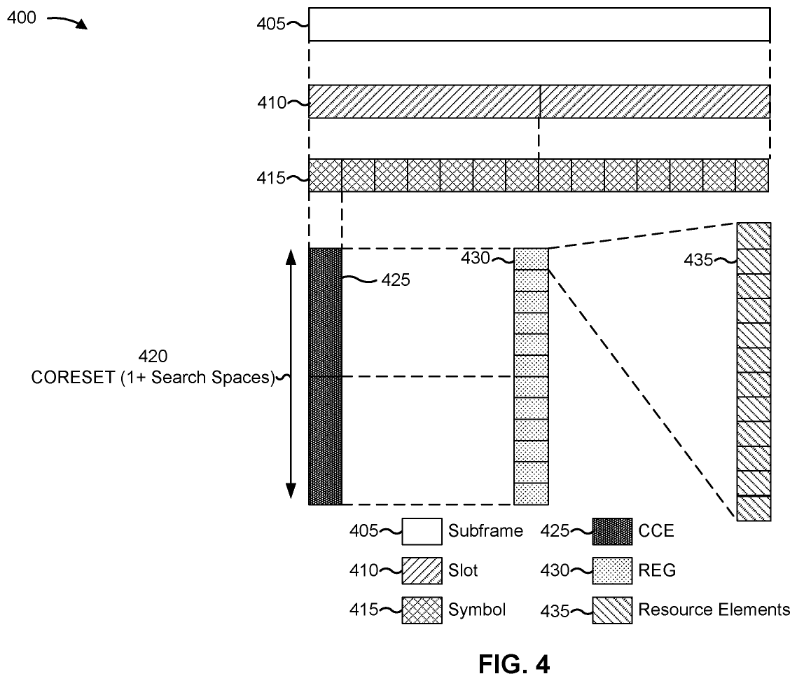

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a control resource set (CORESET) 420 and may be structured to support an efficient use of resources, such as by flexible configuration or reconfiguration of resources of the CORESET 420 for one or more PDCCHs and/or one or more physical downlink shared channels (PDSCHs). In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three consecutive symbols 415 in the time domain. In 5G, a quantity of resources included in the CORESET 420 may be flexibly configured, such as by using radio resource control (RRC) signaling to indicate a frequency domain region (e.g., a quantity of resource blocks) and/or a time domain region (e.g., a quantity of symbols) for the CORESET 420.

As illustrated, a symbol 415 that includes CORESET 420 may include one or more control channel elements (CCEs) 425, shown as two CCEs 425 as an example, that span a portion of the system bandwidth. A CCE 425 may include downlink control information (DCI) that is used to provide control information for wireless communication. A base station may transmit DCI during multiple CCEs 425 (as shown), where the quantity of CCEs 425 used for transmission of DCI represents the aggregation level (AL) used by the BS for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one RB, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

As indicated above, FIG. 4 is provided as an example. Other examples may differ from what is described with respect to FIG. 4.

FIGS. 5A and 5B are diagrams of an example 500 of OTFS-based communication, in accordance with the present disclosure. The example 500 includes communication (e.g., downlink communication) between a base station 110 and a UE 120. As shown in example 500, the base station 110 is a transmitter device that transmits a downlink communication, and the UE 120 is a receiver device that receives the downlink communication. In other examples of OTFS-based communication, a UE may be the transmitter device and a base station may be a receiver device (e.g., for uplink communication) or a first UE may be a transmitter device, and a second UE may be a receiver device (e.g., for sidelink communication).

As shown in FIG. 5A, communication between the base station 110 and the UE 120 may be performed in the time domain 502. A downlink communication that is to be transmitted by the base station 110 to the UE 120 may be converted or transformed to the time domain 502 from one or more other domains, such as a time-frequency domain 504 and a delay-Doppler domain 506.

As further shown in FIG. 5A, the base station 110 may include an OTFS precoder 508. The OTFS precoder 508 receives a plurality of delay-Doppler symbols 510 of the downlink communication and converts the delay-Doppler symbols 510 from the delay-Doppler domain 506 to the time-frequency domain 504. In particular, the OTFS precoder 508 converts or transforms the delay-Doppler symbols 510 to time-frequency symbols 512. The delay-Doppler symbols 510 include a block of M×N delay-Doppler quadrature amplitude modulated (QAM) symbols that are discretized to an M by N delay-Doppler plane that includes M delay samples and N Doppler shift samples. The delay-Doppler symbols 510 may also be referred to as “delay-Doppler” samples. A delay-Doppler sample may be used to transmit an information bit x[k, l], where x[k, l] is the information bit transmitted on the (k, l)th sample/location of the M×N information block in the delay-Doppler domain. The M×N information block in the delay-Doppler domain may be referred to an “OTFS modulation block.” In some examples, the OTFS modulation block for the downlink communication may be a 2048×128 information block (e.g., M=2048 delay domain samples, and N=128 Doppler domain samples). The time-frequency symbols 512 include a block of M×N OFDM modulated symbols that are spread across M subcarriers and N time OFDM symbols. For example, the OTFS precoder 508 may convert or transform a 2048×128 OTFS modulation block into a block of 2048×128 time-frequency symbols that are spread across 2048 subcarriers in the frequency domain and 128 OFDM symbols in the time domain.

As further shown in FIG. 5A, the base station 110 may include an OFDM modulator 514. The OFDM modulator 514 converts or transforms the time-frequency symbols 512 from the time-frequency domain 504 to the time domain 502. In particular, the OFDM modulator 514 modulates the time-frequency symbols 512 using an IFFT (inverse fast Fourier transform) technique to generate a time domain signal 516 that includes the information of the downlink communication. The time domain signal 516 includes a time-varying signal that includes N symbols, each including M samples (e.g., 128 symbols, each including 2048 samples). The base station 110 transmits the time domain signal 516 over a channel 518 (e.g., a wireless downlink channel) as the downlink communication.

The UE 120 receives the time domain signal 516 over the channel 518 from the base station 110. The UE 120 may include an OFDM demodulator 520 that converts or transforms the time domain signal 516 from the time domain 502 to the time-frequency domain 504. In particular, the OFDM demodulator 520 demodulates the time domain signal 516 using an FFT (fast Fourier transform) technique to convert or transform the time domain signal 516 to the time-frequency symbols 512. The UE 120 further includes an OTFS decoder 522. The OTFS decoder 522 may convert or transform the time-frequency symbols 512 from the time-frequency domain 504 to the delay-Doppler domain 506. In particular, the OTFS decoder 522 may decode the time-frequency symbols 512 to obtain the delay-Doppler symbols 510.

As shown in FIG. 5B, the OTFS precoder 508 may apply or use a two-dimensional discrete Fourier transform (DFT), referred to as an inverse symplectic FFT (ISFFT), to convert the delay-Doppler symbols 510 to the time-frequency symbols 512. However, other two-dimensional transforms may be used for OTFS precoding to transform or convert the delay-Doppler symbols 510 to the time-frequency symbols 512.

An ISFFT is a two-dimensional transform that includes an inverse FFT (IFFT) 524 and an FFT 526, where the IFFT 524 is applied in one dimension of a delay-Doppler matrix and the FFT 526 is applied in a second dimension of the delay-Doppler matrix. The OTFS precoder 508 uses the IFFT 524 on the M delay samples of the delay-Doppler symbols 510 and uses the FFT 526 on the N Doppler samples of the delay-Doppler symbols 510 to generate the time-frequency symbols 512. The time-frequency symbols 512 are provided to the OFDM modulator 514. The OFDM modulator 514 includes an IFFT 528 that is used to modulate the time-frequency symbols 512 to generate the time domain signal 516. Note that while the example in FIG. 5B illustrates that the M delay samples of the delay-Doppler symbols 510 are mapped first using the IFFT 524 and the N Doppler samples of the delay-Doppler symbols 510 are mapped second using the FFT 526, the N Doppler samples of the delay-Doppler symbols 510 may be mapped first and the M delay samples of the delay-Doppler symbols 510 may be mapped second. The order has little to no effect on the precoding performance due to the joint detection in OTFS and constant delay-Doppler channel throughout OTFS. The mapping order can be configured by the base station 110 and/or defined in a wireless communication standard or specification (e.g., a 3GPP specification), among other examples.

The OFDM demodulator 520 and the OTFS decoder 522 of the UE 120 may perform reverse operations of those shown in FIG. 5B to demodulate and decode the downlink communication. However, the OTFS decoder 522 uses a symplectic FFT (SFFT) (instead of an ISFFT) to convert the time-frequency symbols 512 to the delay-Doppler symbols 510. The SFFT includes a two-dimensional transform similar to the ISFFT, but a non-inverse version. In some aspects, the OTFS decoder 522 may use another type of two-dimensional transform to convert the time-frequency symbols 512 to the delay-Doppler symbols 510.

As shown in FIGS. 5A and 5B, in an OTFS system, the time-frequency domain 504 part of the OTFS system may operate perform OFDM modulation. Accordingly, in some aspects, OTFS modulation may be realized by an OFDM transceiver by applying the OTFS precoder 508 (e.g., ISFFT) and the OTFS decoder 522 (e.g., SFFT) on top of the OFDM modulation performed by the OFDM transceiver.

As indicated above, FIGS. 5A and 5B are provided as examples. Other examples may differ from what is described with respect to FIGS. 5A and 5B.

In some cases, OFDM modulation and demodulation of wireless communications may be susceptible to high residual frequency offset and/or large Doppler spread. These issues can occur, for example, in high frequency bands and/or high-mobility communication environments. Frequency offset and/or large Doppler spread may result in inter-carrier interference (ICI) (e.g., power leakage among subcarriers) for communications in which OFDM modulation and demodulation is used. A wireless channel may function as a linear time-variant channel in a high-mobility communication environment, as opposed to a linear time-invariant channel that is assumed for OFDM modulation and demodulation. As a result, frequency dispersion and/or time dispersion in a high-mobility communication environment, resulting from high residual frequency offset and/or large Doppler spread, can result in a break-down in orthogonality in OFDM modulation and demodulation, which causes increased ICI. Increased ICI in PDCCH communication may cause a decrease in robustness of PDCCH communications, an increase in dropped or undecodable PDCCH communications, and/or increase in PDCCH retransmissions, among other examples. An increase in PDCCH retransmissions may result in increased consumption of processing, memory, and/or radio resources for UEs that monitor for PDCCH communications.

In some aspects, OTFS modulation (e.g., OTFS precoding and decoding) of PDCCH communications may provide both delay diversity and Doppler diversity for the PDCCH communications, which may mitigate and/or reduce the effects of high residual frequency offset and/or large Doppler shift that can occur in high-mobility communication environments and/or high frequency bands. However, a UE may not be able to monitor for OTFS-based PDCCH communications using a control region (e.g., a search space set) configured for OFDM communications. Without a standard for defining a control region for OTFS-based PDCCH communications, UEs and networks cannot take advantage of the benefits of OTFS modulation of PDCCH communications.

Some techniques and apparatuses described herein enable a base station to transmit, to a UE, a configuration of a control region in the delay-Doppler domain. The base station may apply OTFS precoding to a PDCCH communication included in the control region in the delay-Doppler domain, and the base station may transmit the PDCCH communication with OTFS precoding to the UE. The UE may receive the PDCCH communication with OTFS precoding, and the UE may decode the PDCCH communication with OTFS precoding based at least in part on the configuration of the control region in the delay-Doppler domain. As a result, the UE may monitor for PDCCH communications transmitted with OTFS modulation, which may mitigate and/or reduce the effects of high residual frequency offset and/or large Doppler shift leading to increased robustness of PDCCH communications.

In some cases, although PDCCH communications with OTFS modulation may benefit from delay diversity and Doppler diversity, the OTFS modulation of PDCCH candidates in an OTFS modulation block over a large number of the symbols in the time domain may result in a long delay before the UE can decode all configured PDCCH candidates and determine whether a PDSCH communication is scheduled for the UE. A search space set occasion for OFDM-based PDCCH communications may be configured as the control region in the first 1, 2, or 3 symbols of a slot, which allows a UE to decode the configured PDCCH candidates quickly. In this case, the UE may turn off a baseband module of the UE and enter a micro-sleep mode when the UE determines that the PDCCH candidates in a search space set occasion do not include a PDCCH communication that schedules a PDSCH communication for the UE. In a case in which PDCCH communications are modulated using OTFS, the UE may be required to receive time domain signals for a transmission time associated with an OTFS modulation block. In this case, due to the long transmission time of the OTFS modulation block, the UE may not be able to enter the micro-sleep mode, even when no PDSCH communication is scheduled for the UE. This may result in increased power consumption by the UE, as compared to the power savings associated with entering the micro-sleep mode.

Some techniques and apparatuses described herein enable a base station to transmit, to a UE, a first stage PDCCH communication without OTFS precoding. The first stage PDCCH communication may indicate whether a downlink communication with OTFS precoding is scheduled in an OTFS modulation block. The UE may selectively buffer or not buffer time domain samples associated with the OTFS modulation block based at least in part on the first stage PDCCH communication. The UE may buffer the time domain samples associated with the OTFS modulation block in connection with the first stage PDCCH communication indicating that a downlink communication with OTFS precoding is scheduled in the OTFS modulation block. In this case, the base station may transmit, to the UE, second stage PDCCH communication with OTFS precoding in the time domain samples associated with the OTFS modulation block, and the second stage PDCCH communication may include scheduling information for the downlink communication with the OTFS precoding. The UE may select not to buffer the time domain samples in connection with the first stage PDCCH communication indicating that no downlink communication with OTFS precoding is scheduled in the OTFS modulation block. In this case, the UE may enter a sleep mode for a duration associated with the OTFS modulation block. As a result, the UE may conserve power by entering the sleep mode when no downlink communication is scheduled, and the UE and the network may realize the benefits of the OTFS modulation for the second stage PDCCH communication when a downlink communication is scheduled.

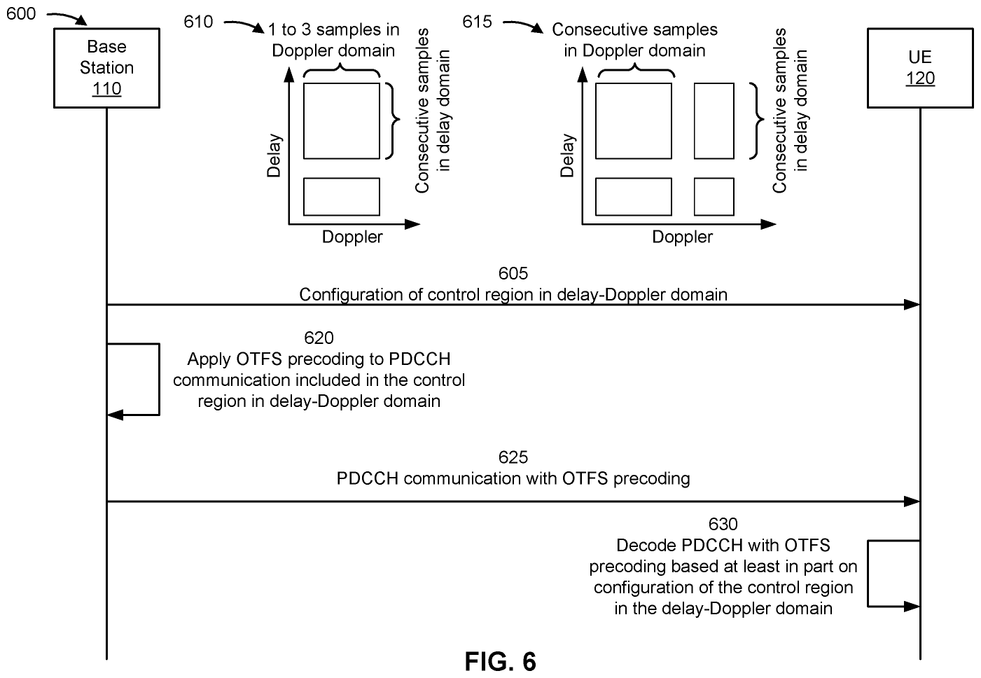

FIG. 6 is a diagram illustrating an example 600 associated with OTFS for PDCCH communications, in accordance with the present disclosure. As shown in FIG. 6, example 600 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As shown in FIG. 6, and by reference number 605, the base station may transmit, to the UE 120, a configuration of a control region in a delay-Doppler domain. The UE 120 may receive the configuration of the control region in the delay-Doppler domain. In some aspects, the base station 110 may transmit the configuration of the control region in the delay-Doppler domain to the UE 120 in an RRC message.

In some aspects, the configuration of the control region may indicate a mapping of the search space set occasion structure configured for OFDM to the delay-Doppler domain with OTFS precoding. For example, the configuration of the control region may indicate a set of allocated delay-Doppler samples for the control region in an information block in the delay-Doppler domain (e.g., an OTFS modulation block). The allocated delay-Doppler samples in the OTFS modulation block may define a search space set occasion, to be monitored by the UE 120, for PDCCH communications with OTFS precoding. In some aspects, the configuration may indicate a mapping of the allocated delay-Doppler symbols (in the delay-Doppler domain) to the time-frequency domain of OFDM.

In some aspects, the configuration of the control region includes a first bitmap that indicates a delay domain resource allocation for the set of allocated delay-Doppler samples. The first bitmap may include a plurality of bits, and each bit in the first bitmap may indicate whether a corresponding group of consecutive samples in the delay domain is included in the delay domain resource allocation for the set of allocated delay-Doppler samples. For example, each bit in the first bitmap may provide an indication for a configured number of consecutive samples in the delay domain. The configured number of consecutive samples may represent a basic unit of the resources occupied by a PDCCH communication in the delay domain. In some aspects, the configured number of consecutive delay domain samples represented by each bit in the first bitmap may be 6*N (e.g., a multiple of 6). In this case, the delay-domain samples may be allocated for the PDCCH search space set occasion with a granularity of 6 or a multiple of 6. For example, the configured number of consecutive delay-domain samples may be 12 (e.g., N=2), similar to the frequency domain for OFDM. A first value (e.g., 1) of a bit in the first bitfield may indicate that the corresponding group of consecutive samples in the delay domain are included in the allocated set of samples for the search space occasion, and a second value (e.g., 0) of a bit in the first bitfield may indicate that the corresponding group of consecutive samples in the delay domain are not included in the allocated set of samples for the search space occasion.

In some aspects, a resource allocation in the Doppler domain may span a number of consecutive samples in the Doppler domain. For example, the Doppler domain resource allocation may span 1, 2, or 3 consecutive samples in the Doppler domain. In this case, the configuration may indicate the number of consecutive samples (e.g., 1, 2, or 3) in the Doppler domain for the Doppler domain resource allocation for the set of allocated delay-Doppler samples. As shown in FIG. 6, a first delay-Doppler domain control region 610 shows an example in which the delay domain resource allocation of control region for the set of allocated delay-Doppler samples is configured with the first bitmap, and the Doppler domain resource allocation for the set of allocated delay-Doppler samples spans 1 to 3 consecutive samples in the Doppler domain.

In some aspects, a PDCCH communication may be transmitted across all of the allocated samples in the Doppler domain and in all or a subset of samples in the delay domain. The delay domain samples used for a PDCCH communication may be determined based at least in part on a PDCCH candidate index associated with the PDCCH communication. For example, a PDCCH candidate may be configured (e.g., via RRC configuration) with a number of samples in the delay domain. The occupied samples (e.g., the samples in which a PDCCH communication is included) in the delay domain for a PDCCH candidate may be selected from all of the allocated samples in the delay domain for the search space set occasion based at least in part on a pseudo random mapping function (e.g., a first mapping function).

In some aspects, a PDCCH may be transmitted over nonconsecutive samples in the Doppler domain. This may provide a benefit of increasing Doppler diversity for the PDCCH communication. In this case, the Doppler domain resource allocation for set of allocated delay-Doppler samples for the search space set occasion may include non-consecutive samples in the Doppler domain. In some aspects, the configuration of the control region may include a second bitmap that indicates the Doppler domain resource allocation for the set of allocated delay-Doppler samples. The second bitmap may include a plurality of bits, and each bit in the second bitmap may indicate whether a corresponding grouping of one or more consecutive samples in the Doppler domain is included in the Doppler domain resource allocation for the set of allocated delay-Doppler samples. For example, each bit in the first bitmap may provide an indication for a configured number M of consecutive samples in the Doppler domain. In some aspects, M may be 1 by default, and the configuration may adjust the value of M to configure granularity of the Doppler domain resource allocation. A first value (e.g., 1) of a bit in the second bitmap may indicate that the corresponding M consecutive samples in the Doppler domain are included in the allocated set of samples for the search space occasion, and a second value (e.g., 0) of a bit in the second bitmap may indicate that the corresponding M consecutive samples in the Doppler domain are not included in the allocated set of samples for the search space occasion.

In some aspects, the configuration may indicate the delay domain resource allocation for the set of allocated delay-Doppler samples using the first bitmap, and the configuration may indicate the Doppler domain resource allocation for the set of allocated delay-Doppler samples using the second bitmap. As shown in FIG. 6, a second delay-Doppler domain control region 615 shows an example in which the delay domain resource allocation for the set of allocated delay-Doppler samples in the control region is configured with the first bitmap, and the Doppler domain resource allocation for the set of allocated delay-Doppler samples in the control region is configured with the second bitmap.

In some aspects, in a case in which the Doppler domain resource allocation for the set of allocated delay-Doppler samples is configured with the second bitmap, a PDCCH communication transmitted in the configured search space set occasion (e.g., control region) may occupy all of the allocated samples for the search space set occasion in the Doppler domain. In some aspects, in the case in which the Doppler domain resource allocation for the set of allocated delay-Doppler samples is configured with the second bitmap, a PDCCH communication transmitted in the configured search space set occasion may occupy a subset of the allocated samples in the Doppler domain. The Doppler domain samples used for a PDCCH communication may be determined based at least in part on the PDCCH candidate index associated with the PDCCH communication. For example, a PDCCH candidate may be configured (e.g., via RRC configuration) with a number of samples in the Doppler domain. The occupied samples (e.g., the samples in which a PDCCH communication is included) in the Doppler domain for a PDCCH candidate may be selected from all of the allocated samples in the Doppler domain for the search space set occasion based at least in part on a pseudo random mapping function (e.g., a second mapping function). This may lead to a distributed resource allocation for a PDCCH communication in the Doppler domain, and thus may provide a benefit of achieving Doppler diversity.

As further shown in FIG. 6, and by reference number 620, the base station 110 may apply OTFS precoding to a PDCCH communication in the control region in the delay-Doppler domain. The control region in the delay-Doppler domain may include the configured set of allocated delay-Doppler samples for the control region (e.g., for the search space set occasion) in the information block (e.g., the OTFS modulation block). The base station 110 may include the PDCCH communication in one or more delay-Doppler samples in the set of allocated delay-Doppler samples in the OTFS modulation block. For example, the PDCCH communication may occupy all or a subset of the allocated delay-Doppler samples in the delay domain, and the PDCCH communication may occupy all or a subset of the allocated delay-Doppler samples in the Doppler domain. In some aspects, the base station 110 may determine the occupied samples the delay domain for a PDCCH candidate based at least in part on a first mapping function (e.g., a first pseudo random mapping function), and the base station 110 may determine the occupied samples in the Doppler domain for the PDCCH candidate based at least in part on a second mapping function (e.g., a second first pseudo random mapping function).

The base station 110 may apply OTFS precoding to the OTFS modulation block that includes the PDCCH communication in the configured control region. For example, the base station 110 may precode the OTFS modulation block that included the PDCCH communication using an OTFS precoder. The OTFS precoder may include an ISFFT.

As further shown in FIG. 6, and by reference number 625, the base station 110 may transmit, to the UE 120, the PDCCH communication with OTFS precoding. The UE 120 may receive the PDCCH communication transmitted by the base station 110 with the OTFS precoding. In some aspects, the base station 110 may apply OFDM modulation (e.g., using an OFDM modulator) to time-frequency symbols resulting from the OTFS precoding of the OTFS modulation block including the PDCCH communication. The base station 110 may then transmit, to the UE 120 a time domain signal resulting from the OFDM modulation. The base station 110, by applying the OTFS precoding and the OFDM modulation to the PDCCH communication (e.g., to the OTFS modulation block including the PDCCH communication), may transmit the PDCCH communication with OTFS modulation.

As further shown in FIG. 6, and by reference number 630, the UE 120 may decode the PDCCH communication with the OTFS precoding based at least in part on the configuration of the control region in the delay-Doppler domain. The UE 120 may apply OTFS decoding to the PDCCH communication with OTFS precoding, resulting in an information block in the delay-Doppler domain (e.g., the OTFS modulation block). For example, the UE 120 may receive the time signal from the base station 110, and the UE 120 may apply OFDM demodulation (e.g., using an OFDM demodulator) to time domain samples included in the time signal to generate a set of time-frequency domain symbols. The UE 120 may then apply OTFS decoding to the set of time-frequency domain symbols resulting from the OFDM demodulation to generate the OTFS modulation block.

The UE 120 may decode the PDCCH communication included in the control region of the OTFS modulation block based at least in part on the configuration of the control region. The configuration of the control region indicates the set of allocated delay-Doppler samples in the OTFS modulation block for the search space set occasion. The UE 120 may identify the set of allocated delay-Doppler samples in the OTFS modulation block for the search space set occasion from the configuration of the control region, and the UE 120 may monitor/decode the set of allocated delay-Doppler samples indicated in the configuration of the control region. The UE 120 may decode the PDCCH communication included in the occupied delay-Doppler samples of the allocated set of delay-Doppler samples.

In some aspects, the PDCCH communication may include scheduling information for scheduled PDSCH communication for the UE 120. The UE 120 may receive and decode the scheduled PDSCH communication based at least in part on the scheduling information included in the PDCCH communication. In some aspects, the scheduled PDSCH communication may be jointly modulated, using OTFS modulation, with the PDCCH communication in the OTFS modulation block. In this case, the base station 110 may apply OTFS precoding to the OTFS modulation block that includes the PDCCH communication and the scheduled PDSCH communication. The UE 120 may identify the delay-Doppler resources (e.g., delay-Doppler samples) in the OTFS modulation block that include the PDSCH communication based at least in part on the scheduling information included in the PDCCH communication.

In some aspects, the PDCCH communication with OTFS precoding may include PDCCH data (e.g., DCI) and a PDCCH DMRS. For example, the base station 110 may apply OTFS precoding to an OTFS modulation block that includes both the PDCCH data and the PDCCH DMRS. In this case, the configuration of the control region may indicate a PDCCH DMRS pattern in the delay-Doppler domain. For example, the PDCCH DMRS pattern may include a pattern of delay-Doppler samples allocated for transmitting the PDCCH DMRS. In this case, the PDCCH DMRS may be allocated on all samples in the Doppler domain, or on a selected subset of samples in the Doppler domain from the set of allocated delay-Doppler samples for the search space occasion.

In some aspects, OTFS precoding/modulation may be applied to repetitions of the same PDCCH communication within the same OTFS modulation block. For example, the OTFS modulation block that includes the PDCCH communication may also include one or more other repetitions of the same PDCCH communication (e.g., in a configured set of allocated delay-Doppler samples for one or more other search space set occasions). OTFS precoding/modulation of an OTFS modulation block including repetitions of the same PDCCH communication may enhance the coverage of the PDCCH communication.

As described above, the base station 110 may transmit, to the UE 120, a configuration of a control region in the delay-Doppler domain. The base station 110 may apply OTFS precoding to a PDCCH communication included in the control region in the delay-Doppler domain, and the base station 110 may transmit the PDCCH communication with OTFS precoding to the UE 120. The UE 120 may receive the PDCCH communication with OTFS precoding, and the UE 120 may decode the PDCCH communication with OTFS precoding based at least in part on the configuration of the control region in the delay-Doppler domain. As a result, the UE 120 may monitor for PDCCH communications transmitted with OTFS modulation, which may mitigate and/or reduce the effects of high residual frequency offset and/or large Doppler shift leading to increased robustness of PDCCH communications.

As indicated above, FIG. 6 is provided as an example. Other examples may differ from what is described with respect to FIG. 6.

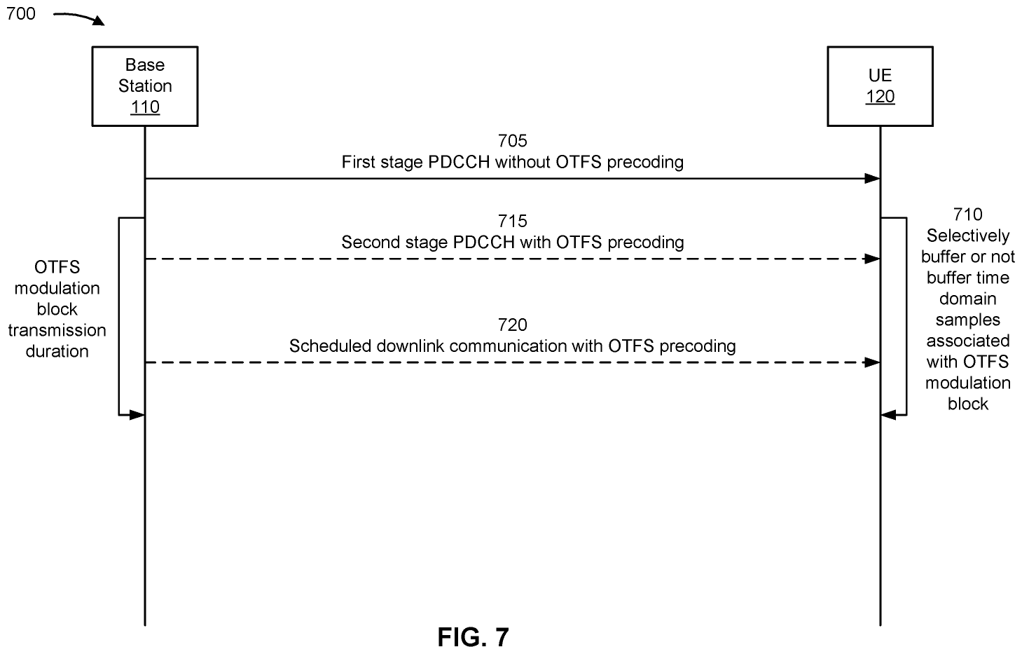

FIG. 7 is a diagram illustrating an example 700 associated with OTFS modulation for PDCCH communications, in accordance with the present disclosure. As shown in FIG. 7, example 700 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink.

As shown in FIG. 7, and by reference number 705, the base station 110 may transmit, to the UE 120, a first stage PDCCH communication without OTFS precoding. The base station 110 may transmit the first stage PDCCH communication to the UE 120 in a search space set occasion configured for first stage PDCCH communications. The UE 120 may monitor the search space set occasion configured for the first stage PDCCH communications, and the UE 120 may receive and decode the first stage PDCCH communication.

The first stage PDCCH communication may be transmitted by the base station 110 without applying OTFS precoding. For example, the base station 110 may apply OFDM modulation (e.g., using an IFFT modulation) to the first stage PDCCH communication without applying OTFS precoding. The search space set occasion for the first stage PDCCH communication may precede or be scheduled at the beginning of a transmission duration associated with transmission of an OTFS modulation block with using OTFS modulation (e.g., with OTFS precoding). The transmission duration associated with the OTFS modulation block may be a time duration in which time domain samples associated with the OTFS modulation block are transmitted from the base station 110. For example, for 2048×128 OTFS modulation block, the transmission duration may be a time duration associated with transmitted a time domain signal including 2048*148 time domain samples. In some aspects, the first stage PDCCH communication indicates whether a downlink communication (e.g., a PDSCH communication and/or a downlink reference signal) with OTFS precoding is scheduled in the upcoming OTFS modulation block.

In some aspects, the first stage PDCCH communication may be quickly decoded by the UE 120. In some aspects, the first stage PDCCH communication may include DCI with a small payload size (e.g., smaller than a payload size of second stage PDCCH DCI that is transmitted with OTFS precoding in the OTFS modulation block), such that decoding performance can be guaranteed even though Doppler diversity is not achieved.

In some aspects, the first stage PDCCH communication may only indicate whether or not one OTFS modulation block (e.g., a subsequent or concurrent OTFS modulation block) includes a scheduled downlink communication (e.g., PDSCH or CSI-RS). The indication, in the first stage PDCCH communication, that a scheduled downlink communication (e.g., PDSCH or CSI-RS) is included in the OTFS modulation block may also provide an implicit indication to the UE 120 that the OTFS modulation block includes a second stage PDCCH communication that provides scheduling information and/or other parameters for the scheduled downlink communication in the OTFS modulation block. In some aspects, at least a part of the OTFS block may be transmitted by the base station 110 before the first stage PDCCH communication. In some aspects, in addition to the indication of whether a downlink communication is included in the OTFS modulation block, the first stage PDCCH communication may also include an indication of resource information for the scheduled downlink communication in the OTFS modulation block, such as at a starting delay-Doppler domain sample and/or a length in delay-Doppler domain samples for the scheduled downlink communication in the OTFS modulation block.

As further shown in FIG. 7, and by reference number 710, the UE 120 may selectively buffer or not buffer time domain samples associated with the OTFS modulation block during an OTFS modulation block transmission duration based at least in part on the first stage PDCCH communication.

In some aspects, the UE 120, in connection with the first stage PDCCH communication indicating that no downlink communication (e.g., PDSCH or CSI-RS) with OTFS precoding is scheduled for the UE 120 in the OTFS modulation block, may select not to buffer the time domain samples associated with the OTFS modulation block. In this case, the UE 120 may enter a sleep mode (e.g., a micro-sleep mode) for the OTFS modulation block transmission duration based at least in part on the first stage PDCCH communication indicating that no downlink communication with OTFS precoding is scheduled in the OTFS modulation block. For example, the UE 120 may turn off a baseband module of the UE 120 for the OFDM symbols in the OTFS modulation block transmission duration. In some aspects, the UE 120 may begin buffering time domain samples during decoding of the first stage PDCCH communication. In this case, the UE 120, in connection with decoding the first stage PDCCH communication that indicates that no downlink communication is scheduled for the UE 120 in the OTFS modulation block, may stop buffering the time domain samples associated with the OTFS modulation block, discard the buffered time domain samples associated with the OTFS modulation block, and enter the sleep mode for the remaining portion of the OTFS modulation block transmission duration. In some aspects, the UE 120 may remain in the sleep mode until a next search space set occasion for the first stage PDCCH.

In some aspects, the UE 120, in connection with the first stage PDCCH communication indicating that a downlink communication (e.g., PDSCH or CSI-RS) with OTFS precoding is scheduled for the UE 120 in the OTFS modulation block, may buffer the time domain samples associated with the OTFS modulation block for OTFS modulation block transmission duration. In this case, the UE 120 may monitor a configured delay-Doppler domain control region (e.g., search space occasion) in the OTFS modulation for second stage PDCCH that is transmitted with OTFS precoding. The control region in the delay-Doppler domain may be configured for the second stage PDCCH as described above in connection with FIG. 6.

As further shown in FIG. 7, and by reference number 715, the base station 110 may transmit, to the UE 120, a second stage PDCCH communication with OTFS precoding in the OTFS modulation block. The base station 110 may transmit the second stage PDCCH communication with OTFS precoding to the UE 120 in a case in which the first stage PDCCH communication indicates that a downlink communication (e.g., PDSCH or CSI-RS) is scheduled for the UE 120 in the OTFS modulation block. The base station 110 may transmit the second stage PDCCH in the time domain samples associated with the OTFS modulation block. The UE 120 may buffer the time domain samples associated with the modulation block in connection with the first stage PDCCH communication indicating that a downlink communication is scheduled for the UE 120 in the OTFS modulation block.

The UE 120 may receive the second stage PDCCH communication with the OTFS precoding in the time domain samples associated with the OTFS modulation block. The UE 120 may decode the second stage PDCCH communication based at least in part on a configured control region in the delay-Doppler domain for the second stage PDCCH communication, as described above in connection with FIG. 6. In some aspects, the second stage PDCCH communication may include scheduling information for the downlink communication with OTFS precoding scheduled for the UE 120 in the OTFS modulation block. For example, the scheduling information in the second stage PDCCH communication may include detailed scheduling information for a scheduled downlink communication, such as hybrid automatic repeat request (HARQ) information for the scheduled downlink communication, an MCS for the scheduled downlink communication, and/or a full two-dimensional resource allocation in the delay-Doppler domain for the scheduled downlink communication, among other examples. In some aspects, the scheduled downlink communication may be a channel (e.g., PDSCH) or reference signal (e.g., CSI-RS).

As further shown in FIG. 7, and by reference number 720, the base station 110 may transmit, to the UE 120, the scheduled downlink communication with OTFS precoding in the OTFS modulation block. The base station 110 may transmit the scheduled downlink communication (e.g., PDSCH or CSI-RS) in the time domain samples associated with the OTFS modulation block. The UE 120 may buffer the time domain samples associated with the modulation block in connection with the first stage PDCCH communication indicating that a downlink communication is scheduled for the UE 120 in the OTFS modulation block.

The UE 120 may receive the time domain samples associated with the OTFS modulation block included the scheduled downlink communication with OTFS precoding. The UE 120 may decode the scheduled downlink communication based at least in part on the scheduling information included in the second stage PDCCH communication.

As indicated above, FIG. 7 is provided as an example. Other examples may differ from what is described with respect to FIG. 7.

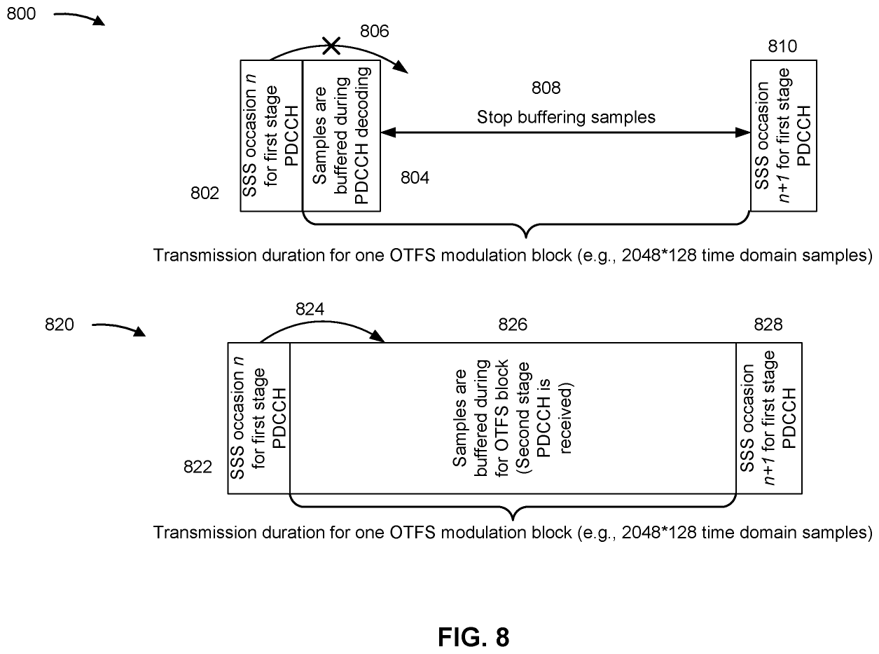

FIG. 8 is a diagram illustrating examples 800 and 820 associated with OTFS for PDCCH communications, in accordance with the present disclosure. Example 800 shows an example in which a UE 120 stops buffering time domain samples associated with an OTFS modulation block. As shown by reference number 802, the UE 120 may receive a first stage PDCCH communication in a search space set occasion (e.g., SSS occasion n) for first stage PDCCH. As shown by reference number 804, the UE 120 may start buffering time domain samples associated with an OTFS modulation block during decoding of the first stage PDCCH communication. As shown by reference number 806, the first stage PDCCH may indicate that the OTFS modulation block does not include a scheduled downlink communication for the UE 120. As shown by reference number 808, the UE 120, in connection with receiving the first stage PDCCH communication that indicates that the OTFS modulation block does not include a scheduled downlink communication for the UE 120, may stop buffering the time domain samples associated with the OTFS modulation block. The UE 120 may discard the time domain samples buffered during decoding the first stage PDCCH communication, and the UE 120 may enter a sleep mode for the remainder of the transmission duration for the OTFS modulation block. As shown by reference number 810, the UE 120 may exit the sleep mode and monitor a next search space set occasion (e.g., SSS occasion n+1) for first stage PDCCH.

Example 820 shows an example in which a UE 120 buffers time domain samples associated with an OTFS modulation block. As shown by reference number 822, the UE 120 may receive a first stage PDCCH communication in a search space set occasion (e.g., SSS occasion n) for first stage PDCCH. As shown by reference number 824, the first stage PDCCH may indicate that the OTFS modulation block includes a scheduled downlink communication for the UE 120. As shown by reference number 826, the UE 120, in connection with receiving the first stage PDCCH communication that indicates that the OTFS modulation block includes a scheduled downlink communication for the UE 120, may buffer the time domain samples associated with the OTFS modulation block for the transmission duration of the OTFS modulation block. The UE 120 may receive a second stage PDCCH communication with OTFS precoding in the time domain samples associated with the OTFS modulation block. The UE 120 may also receive a scheduled downlink communication in the time domain samples associated with the OTFS modulation block based at least in part on scheduling information included in the second stage PDCCH communication. As shown by reference number 828, the UE 120 may monitor a next search space set occasion (e.g., SSS occasion n+1) for first stage PDCCH.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the ULE (e.g., UE 120) performs operations associated with OTFS modulation for PDCCH communications.

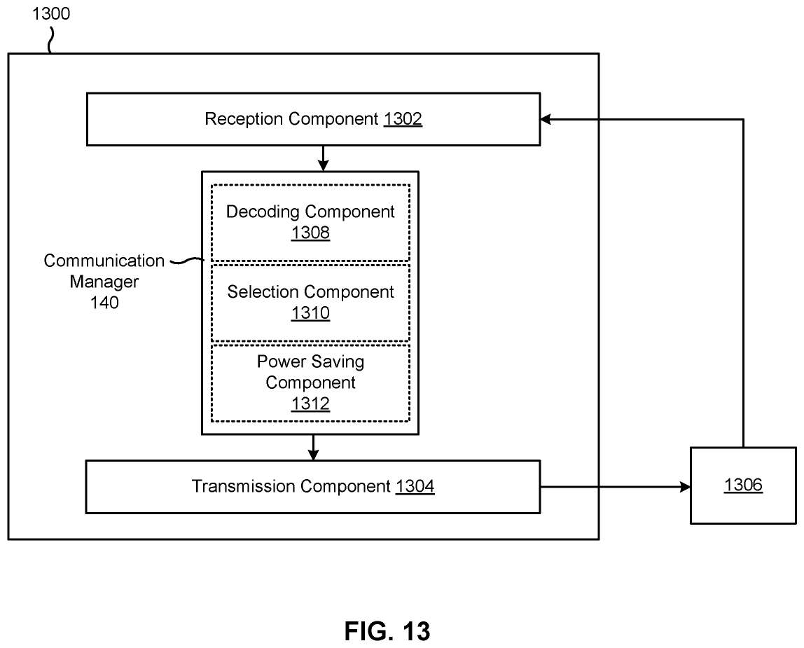

As shown in FIG. 9, in some aspects, process 900 may include receiving, from a base station, a configuration of a control region in a delay-Doppler domain (block 910). For example, the UE (e.g., using communication manager 140 and/or reception component 1302, depicted in FIG. 13) may receive, from a base station, a configuration of a control region in a delay-Doppler domain, as described above.

As further shown in FIG. 9, in some aspects, process 900 may include receiving, from the base station, a PDCCH communication with OTFS precoding (block 920). For example, the UE (e.g., using communication manager 140 and/or reception component 1302, depicted in FIG. 13) may receive, from the base station, a PDCCH communication with OTFS precoding, as described above.

As further shown in FIG. 9, in some aspects, process 900 may include decoding the PDCCH communication with OTFS precoding based at least in part on the configuration of the control region in the delay-Doppler domain (block 930). For example, the UE (e.g., using communication manager 140 and/or decoding component 1308, depicted in FIG. 13) may decode the PDCCH communication with OTFS precoding based at least in part on the configuration of the control region in the delay-Doppler domain, as described above.

Process 900 may include additional aspects, such as any single aspect or any combination of aspects described below and/or in connection with one or more other processes described elsewhere herein.

In a first aspect, decoding the PDCCH communication with OTFS precoding includes applying OTFS decoding to the PDCCH communication with OTFS precoding, resulting in an information block in the delay-Doppler domain, and decoding the PDCCH communication based at least in part on the configuration of the control region, where the configuration of the control region indicates a set of allocated delay-Doppler samples for the control region in the information block, and the PDCCH communication is included in one or more delay-Doppler samples in the set of allocated delay-Doppler samples.

In a second aspect, the configuration of the control region includes a first bitmap that indicates a delay domain resource allocation for the set of allocated delay-Doppler samples, and the first bitmap includes a first plurality of bits, and each bit of the first plurality of bits indicates whether a corresponding group of consecutive samples in the delay domain is included in the delay domain resource allocation for the set of allocated delay-Doppler samples.

In a third aspect, the configuration indicates a number of consecutive samples in a Doppler domain for a Doppler domain resource allocation for the set of allocated delay-Doppler samples.

In a fourth aspect, the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

In a fifth aspect, the configuration of the control region includes a second bitmap that indicates a Doppler domain resource allocation for the set of allocated delay-Doppler samples, and the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

In a sixth aspect, the one or more delay-Doppler samples, in which the PDCCH communication is included, comprise all of the Doppler domain resource allocation for the set of allocated delay-Doppler samples.

In a seventh aspect, the one or more delay-Doppler samples, in which the PDCCH communication is included, comprise a subset of the Doppler domain resource allocation for the set of allocated delay-Doppler samples.

In an eighth aspect, the PDCCH communication with OTFS precoding includes PDCCH data and a PDCCH DMRS, and the configuration of the control region indicates an allocation of the PDCCH DMRS on all or a subset of delay-Doppler samples in the set of allocated delay-Doppler samples.

In a ninth aspect, the PDCCH communication with PDCCH precoding includes scheduling information for a PDSCH communication, the PDSCH communication is jointly modulated with the PDCCH communication in the information block.

In a tenth aspect, process 900 includes decoding the PDSCH communication jointly modulated with the PDCCH communication in the information block based at least in part on the scheduling information.

In an eleventh aspect, the information block includes multiple repetitions of the PDCCH communication with OTFS precoding.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with OTFS for PDCCH communications.

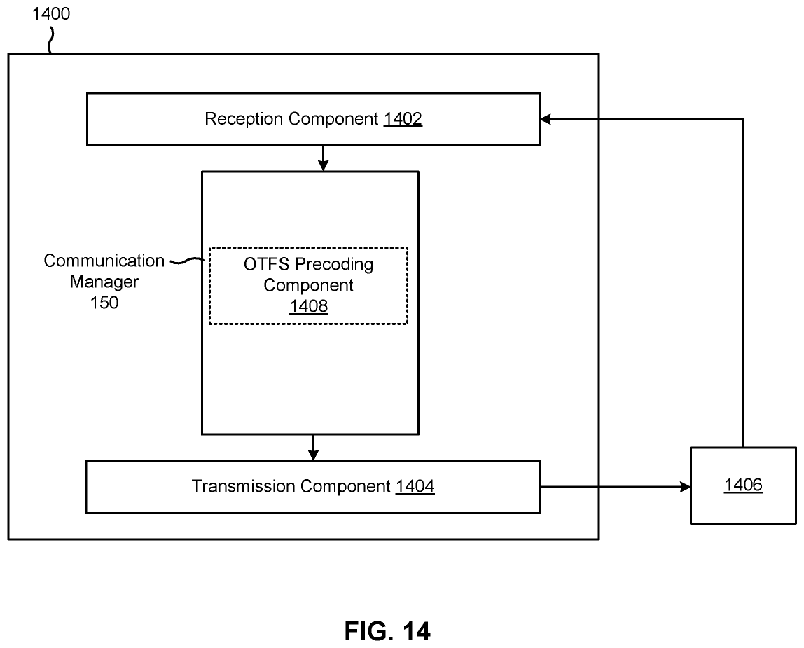

As shown in FIG. 10, in some aspects, process 1000 may include transmitting, to a UE, a configuration of a control region in a delay-Doppler domain (block 1010). For example, the base station (e.g., using communication manager 150 and/or transmission component 1404, depicted in FIG. 14) may transmit, to a UE, a configuration of a control region in a delay-Doppler domain, as described above.

As further shown in FIG. 10, in some aspects, process 1000 may include applying OTFS precoding to a PDCCH communication included in the control region in the delay-Doppler domain (block 1020). For example, the base station (e.g., using communication manager 150 and/or OTFS precoding component 1408, depicted in FIG. 14) may apply OTFS precoding to a PDCCH communication included in the control region in the delay-Doppler domain, as described above.

As further shown in FIG. 10, in some aspects, process 1000 may include transmitting, to the UE, the PDCCH communication with OTFS precoding (block 1030). For example, the base station (e.g., using communication manager 150 and/or transmission component 1404, depicted in FIG. 14) may transmit, to the UE, the PDCCH communication with OTFS precoding, as described above.

Process 1000 may include additional aspects, such as any single aspect or any combination of aspects described below and/or in connection with one or more other processes described elsewhere herein.

In a first aspect, decoding the PDCCH communication with OTFS precoding includes applying OTFS precoding to an information block in the delay-Doppler domain, the configuration of the control region indicates a set of allocated delay-Doppler samples for the control region in the information block, and the PDCCH communication is included in one or more delay-Doppler samples in the set of allocated delay-Doppler samples.

In a second aspect, the configuration of the control region includes a first bitmap that indicates a delay domain resource allocation for the set of allocated delay-Doppler samples, and the first bitmap includes a first plurality of bits, and each bit of the first plurality of bits indicates whether a corresponding group of consecutive samples in the delay domain is included in the delay domain resource allocation for the set of allocated delay-Doppler samples.

In a third aspect, the configuration indicates a number of consecutive samples in a Doppler domain for a Doppler domain resource allocation for the set of allocated delay-Doppler samples.

In a fourth aspect, the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

In a fifth aspect, the configuration of the control region includes a second bitmap that indicates a Doppler domain resource allocation for the set of allocated delay-Doppler samples, and the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

In a sixth aspect, the one or more delay-Doppler samples, in which the PDCCH communication is included, comprise all of the Doppler domain resource allocation for the set of allocated delay-Doppler samples.

In a seventh aspect, the one or more delay-Doppler samples, in which the PDCCH communication is included, comprise a subset of the Doppler domain resource allocation for the set of allocated delay-Doppler samples.

In an eighth aspect, the PDCCH communication with OTFS precoding includes PDCCH data and a PDCCH DMRS, and the configuration of the control region indicates an allocation of the PDCCH DMRS on all or a subset of delay-Doppler samples in the set of allocated delay-Doppler samples.

In a ninth aspect, the PDCCH communication with PDCCH precoding includes scheduling information for a PDSCH communication, and the PDSCH communication is jointly modulated with the PDCCH communication in the information block.

In a tenth aspect, the information block includes multiple repetitions of the PDCCH communication with OTFS precoding.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the ULE (e.g., UE 120) performs operations associated with OTFS modulation for PDCCH communication.

As shown in FIG. 11, in some aspects, process 1100 may include receiving, from a base station, a first stage PDCCH communication without OTFS precoding, wherein the first stage PDCCH communication indicates whether a downlink communication with OTFS precoding is scheduled in an OTFS modulation block (block 1110). For example, the UE (e.g., using communication manager 140 and/or reception component 1302, depicted in FIG. 13) may receive, from a base station, a first stage PDCCH communication without OTFS precoding, wherein the first stage PDCCH communication indicates whether a downlink communication with OTFS precoding is scheduled in an OTFS modulation block, as described above.

As further shown in FIG. 11, in some aspects, process 1100 may include selectively buffering or not buffering time domain samples associated with the OTFS modulation block based at least in part on the first stage PDCCH communication (block 1120). For example, the UE (e.g., using communication manager 140 and/or selection component 1310, depicted in FIG. 13) may selectively buffer or not buffering time domain samples associated with the OTFS modulation block based at least in part on the first stage PDCCH communication, as described above.

Process 1100 may include additional aspects, such as any single aspect or any combination of aspects described below and/or in connection with one or more other processes described elsewhere herein.

In a first aspect, selectively buffering or not buffering the time domain samples associated with the OTFS modulation block includes buffering the time domain samples associated with the OTFS modulation block in connection with the first stage PDCCH communication indicating that the downlink communication with OTFS precoding is scheduled in the OTFS modulation block.

In a second aspect, the first stage PDCCH communication includes an indication of at least one of a starting delay-Doppler domain sample or a length in delay-Doppler domain samples for the downlink communication with OTFS precoding scheduled in the OTFS modulation block.

In a third aspect, process 1100 includes receiving a second stage PDCCH communication with OTFS precoding in the time domain samples associated with the OTFS modulation block, and the second stage PDCCH communication includes scheduling information for the downlink communication with OTFS precoding scheduled in the OTFS modulation block.

In a fourth aspect, process 1100 includes decoding the downlink communication with OTFS precoding from the time domain samples associated with the OTFS modulation block based at least in part on the scheduling information included in the second stage PDCCH communication.

In a fifth aspect, selectively buffering or not buffering the time domain samples associated with the OTFS modulation block includes selecting not to buffer the time domain samples associated with the OTFS modulation block based at least in part on the first stage PDCCH communication indicating that no downlink communication with OTFS precoding is scheduled in the OTFS modulation block.

In a sixth aspect, process 1100 includes entering a sleep mode for a duration associated with the OTFS modulation block based at least in part on the first stage PDCCH communication indicating that no downlink communication with OTFS precoding is scheduled in the OTFS modulation block.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with OTFS modulation for PDCCH communications.

As shown in FIG. 12, in some aspects, process 1200 may include transmitting, to a UE, a first stage PDCCH communication without OTFS precoding, wherein the first stage PDCCH communication indicates whether a downlink communication with OTFS precoding is scheduled for the UE in an OTFS modulation block (block 1210). For example, the base station (e.g., using communication manager 150 and/or transmission component 1404, depicted in FIG. 14) may transmit, to a UE, a first stage PDCCH communication without OTFS precoding, wherein the first stage PDCCH communication indicates whether a downlink communication with OTFS precoding is scheduled for the UE in an OTFS modulation block, as described above.

As further shown in FIG. 12, in some aspects, process 1200 may include transmitting, to the UE, a second stage PDCCH communication with OTFS precoding, wherein the second stage PDCCH communication includes scheduling information for the downlink communication with OTFS precoding scheduled in the OTFS modulation block, and the second stage PDCCH communication with OTFS is included in the OTFS modulation block (block 1220). For example, the base station (e.g., using communication manager 150 and/or transmission component 1404, depicted in FIG. 14) may transmit, to a UE, a second stage PDCCH communication with OTFS precoding, wherein the second stage PDCCH communication includes scheduling information for the downlink communication with OTFS precoding scheduled in the OTFS modulation block, and the second stage PDCCH communication with OTFS is included in the OTFS modulation block, as described above.

Process 1200 may include additional aspects, such as any single aspect or any combination of aspects described below and/or in connection with one or more other processes described elsewhere herein.

In a first aspect, the first stage PDCCH communication indicates that the downlink communication with OTFS precoding is scheduled for the UE in the OTFS modulation block.

In a second aspect, the first stage PDCCH communication includes an indication of at least one of a starting delay-Doppler domain sample or a length in delay-Doppler domain samples for the downlink communication with OTFS precoding scheduled in the OTFS modulation block.

In a third aspect, the first stage PDCCH communication indicates that no downlink communication with OTFS precoding is scheduled for the UE in the OTFS modulation block.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a decoding component 1308, a selection component 1310, or a power saving component 1312, among other examples.

In some aspects, the apparatus 1300 may be configured to perform one or more operations described herein in connection with FIGS. 6-8. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, from a base station, a configuration of a control region in a delay-Doppler domain. The reception component 1302 may receive, from the base station, a PDCCH communication with OTFS precoding. The decoding component 1308 may decode the PDCCH communication with OTFS precoding based at least in part on the configuration of the control region in the delay-Doppler domain.

The decoding component 1308 may decode the PDSCH communication jointly modulated with the PDCCH communication in the information block based at least in part on the scheduling information.

The reception component 1302 may receive, from a base station, a first stage PDCCH communication without OTFS precoding, wherein the first stage PDCCH communication indicates whether a downlink communication with OTFS precoding is scheduled in an OTFS modulation block. The selection component 1310 may selectively buffer or not buffering time domain samples associated with the OTFS modulation block based at least in part on the first stage PDCCH communication.

The reception component 1302 may receive a second stage PDCCH communication with OTFS precoding in the time domain samples associated with the OTFS modulation block, wherein the second stage PDCCH communication includes scheduling information for the downlink communication with OTFS precoding scheduled in the OTFS modulation block.

The decoding component 1308 may decode the downlink communication with OTFS precoding from the time domain samples associated with the OTFS modulation block based at least in part on the scheduling information included in the second stage PDCCH communication.

The power saving component 1312 may enter a sleep mode for a duration associated with the OTFS modulation block based at least in part on the first stage PDCCH communication indicating that no downlink communication with OTFS precoding is scheduled in the OTFS modulation block.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include an OTFS precoding component 1408, among other examples.

In some aspects, the apparatus 1400 may be configured to perform one or more operations described herein in connection with FIGS. 6-8. Additionally, or alternatively, the apparatus 1400 may be configured to perform one or more processes described herein, such as process 1000 of FIG. 10, process 1200 of FIG. 12, or a combination thereof. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

The transmission component 1404 may transmit, to a UE, a configuration of a control region in a delay-Doppler domain. The OTFS precoding component 1408 may apply OTFS precoding to a PDCCH communication included in the control region in the delay-Doppler domain. The transmission component 1404 may transmit, to the UE, the PDCCH communication with OTFS precoding.

The transmission component 1404 may transmit, to a UE, a first stage PDCCH communication without OTFS precoding, wherein the first stage PDCCH communication indicates whether a downlink communication with OTFS precoding is scheduled for the UE in an OTFS modulation block.

The transmission component 1404 may transmit, to the UE, a second stage PDCCH communication with OTFS precoding, wherein the second stage PDCCH communication includes scheduling information for the downlink communication with OTFS precoding scheduled in the OTFS modulation block, wherein the second stage PDCCH communication with OTFS is included in the OTFS modulation block.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a base station, a configuration of a control region in a delay-Doppler domain; receiving, from the base station, a physical downlink control channel (PDCCH) communication with orthogonal time frequency space (OTFS) precoding; and decoding the PDCCH communication with OTFS precoding based at least in part on the configuration of the control region in the delay-Doppler domain.

Aspect 2: The method of Aspect 1, wherein decoding the PDCCH communication with OTFS precoding comprises: applying OTFS decoding to the PDCCH communication with OTFS precoding, resulting in an information block in the delay-Doppler domain; and decoding the PDCCH communication based at least in part on the configuration of the control region, wherein the configuration of the control region indicates a set of allocated delay-Doppler samples for the control region in the information block, and wherein the PDCCH communication is included in one or more delay-Doppler samples in the set of allocated delay-Doppler samples.

Aspect 3: The method of Aspect 2, wherein the configuration of the control region includes a first bitmap that indicates a delay domain resource allocation for the set of allocated delay-Doppler samples, and wherein the first bitmap includes a first plurality of bits, and each bit of the first plurality of bits indicates whether a corresponding group of consecutive samples in the delay domain is included in the delay domain resource allocation for the set of allocated delay-Doppler samples.

Aspect 4: The method of Aspect 3, wherein the configuration indicates a number of consecutive samples in a Doppler domain for a Doppler domain resource allocation for the set of allocated delay-Doppler samples.

Aspect 5: The method of Aspect 4, wherein the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

Aspect 6: The method of Aspect 3, wherein the configuration of the control region includes a second bitmap that indicates a Doppler domain resource allocation for the set of allocated delay-Doppler samples, and wherein the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

Aspect 7: The method of Aspect 6, wherein the one or more delay-Doppler samples, in which the PDCCH communication is included, comprise all of the Doppler domain resource allocation for the set of allocated delay-Doppler samples.

Aspect 8: The method of Aspect 6, wherein the one or more delay-Doppler samples, in which the PDCCH communication is included, comprise a subset of the Doppler domain resource allocation for the set of allocated delay-Doppler samples.

Aspect 9: The method of any of Aspects 2-8, wherein the PDCCH communication with OTFS precoding includes PDCCH data and a PDCCH demodulation reference signal (DMRS), and wherein the configuration of the control region indicates an allocation of the PDCCH DMRS on all or a subset of delay-Doppler samples in the set of allocated delay-Doppler samples.

Aspect 10: The method of any of Aspects 2-9, wherein the PDCCH communication with PDCCH precoding includes scheduling information for a physical downlink shared channel (PDSCH) communication, wherein the PDSCH communication is jointly modulated with the PDCCH communication in the information block.

Aspect 11: The method of Aspect 10, further comprising: decoding the PDSCH communication jointly modulated with the PDCCH communication in the information block based at least in part on the scheduling information.

Aspect 12: The method of any of Aspects 2-11, wherein the information block includes multiple repetitions of the PDCCH communication with OTFS precoding.

Aspect 13: A method of wireless communication performed by a base station, comprising: transmitting, to a user equipment (UE), a configuration of a control region in a delay-Doppler domain; applying orthogonal time frequency space (OTFS) precoding to a physical downlink control channel (PDCCH) communication included in the control region in the delay-Doppler domain; and transmitting, to the UE, the PDCCH communication with OTFS precoding.

Aspect 14: The method of Aspect 13, wherein decoding the PDCCH communication with OTFS precoding comprises: applying OTFS precoding to an information block in the delay-Doppler domain, wherein the configuration of the control region indicates a set of allocated delay-Doppler samples for the control region in the information block, and wherein the PDCCH communication is included in one or more delay-Doppler samples in the set of allocated delay-Doppler samples.

Aspect 15: The method of Aspect 14, wherein the configuration of the control region includes a first bitmap that indicates a delay domain resource allocation for the set of allocated delay-Doppler samples, and wherein the first bitmap includes a first plurality of bits, and each bit of the first plurality of bits indicates whether a corresponding group of consecutive samples in the delay domain is included in the delay domain resource allocation for the set of allocated delay-Doppler samples.

Aspect 16: The method of Aspect 15, wherein the configuration indicates a number of consecutive samples in a Doppler domain for a Doppler domain resource allocation for the set of allocated delay-Doppler samples.

Aspect 17: The method of Aspect 16, wherein the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

Aspect 18: The method of Aspect 15, wherein the configuration of the control region includes a second bitmap that indicates a Doppler domain resource allocation for the set of allocated delay-Doppler samples, and wherein the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

Aspect 19: The method of Aspect 18, wherein the one or more delay-Doppler samples, in which the PDCCH communication is included, comprise all of the Doppler domain resource allocation for the set of allocated delay-Doppler samples.

Aspect 20: The method of Aspect 18, wherein the one or more delay-Doppler samples, in which the PDCCH communication is included, comprise a subset of the Doppler domain resource allocation for the set of allocated delay-Doppler samples.

Aspect 21: The method of any of Aspects 14-20, wherein the PDCCH communication with OTFS precoding includes PDCCH data and a PDCCH demodulation reference signal (DMRS), and wherein the configuration of the control region indicates an allocation of the PDCCH DMRS on all or a subset of delay-Doppler samples in the set of allocated delay-Doppler samples.

Aspect 22: The method of any of Aspects 14-21, wherein the PDCCH communication with PDCCH precoding includes scheduling information for a physical downlink shared channel (PDSCH) communication, wherein the PDSCH communication is jointly modulated with the PDCCH communication in the information block.

Aspect 23: The method of any of Aspects 14-22, wherein the information block includes multiple repetitions of the PDCCH communication with OTFS precoding.

Aspect 24: A method of wireless communication performed by a user equipment (UE), comprising: receiving, from a base station, a first stage physical downlink control channel (PDCCH) communication without orthogonal time frequency space (OTFS) precoding, wherein the first stage PDCCH communication indicates whether a downlink communication with OTFS precoding is scheduled in an OTFS modulation block; and selectively buffering or not buffering time domain samples associated with the OTFS modulation block based at least in part on the first stage PDCCH communication.

Aspect 25: The method of Aspect 24, wherein selectively buffering or not buffering the time domain samples associated with the OTFS modulation block comprises: buffering the time domain samples associated with the OTFS modulation block in connection with the first stage PDCCH communication indicating that the downlink communication with OTFS precoding is scheduled in the OTFS modulation block.

Aspect 26: The method of Aspect 25, wherein the first stage PDCCH communication includes an indication of at least one of a starting delay-Doppler domain sample or a length in delay-Doppler domain samples for the downlink communication with OTFS precoding scheduled in the OTFS modulation block.

Aspect 27: The method of any of Aspects 25-26, further comprising: receiving a second stage PDCCH communication with OTFS precoding in the time domain samples associated with the OTFS modulation block, wherein the second stage PDCCH communication includes scheduling information for the downlink communication with OTFS precoding scheduled in the OTFS modulation block.

Aspect 28: The method of Aspect 27, further comprising: decoding the downlink communication with OTFS precoding from the time domain samples associated with the OTFS modulation block based at least in part on the scheduling information included in the second stage PDCCH communication.

Aspect 29: The method of Aspect 24, wherein selectively buffering or not buffering the time domain samples associated with the OTFS modulation block comprises: selecting not to buffer the time domain samples associated with the OTFS modulation block based at least in part on the first stage PDCCH communication indicating that no downlink communication with OTFS precoding is scheduled in the OTFS modulation block.

Aspect 30: The method of Aspect 29, further comprising: entering a sleep mode for a duration associated with the OTFS modulation block based at least in part on the first stage PDCCH communication indicating that no downlink communication with OTFS precoding is scheduled in the OTFS modulation block.

Aspect 31: A method of wireless communication performed by a base station, comprising: transmitting, to a user equipment (UE), a first stage physical downlink control channel (PDCCH) communication without orthogonal time frequency space (OTFS) precoding, wherein the first stage PDCCH communication indicates whether a downlink communication with OTFS precoding is scheduled for the UE in an OTFS modulation block.

Aspect 32: The method of Aspect 31, wherein the first stage PDCCH communication indicates that the downlink communication with OTFS precoding is scheduled for the UE in the OTFS modulation block.

Aspect 33: The method of Aspect 32, further comprising: transmitting, to the UE, a second stage PDCCH communication with OTFS precoding, wherein the second stage PDCCH communication includes scheduling information for the downlink communication with OTFS precoding scheduled in the OTFS modulation block, wherein the second stage PDCCH communication with OTFS is included in the OTFS modulation block.

Aspect 34: The method of any of Aspects 32-33, wherein the first stage PDCCH communication includes an indication of at least one of a starting delay-Doppler domain sample or a length in delay-Doppler domain samples for the downlink communication with OTFS precoding scheduled in the OTFS modulation block.

Aspect 35: The method of Aspect 31, wherein the first stage PDCCH communication indicates that no downlink communication with OTFS precoding is scheduled for the UE in the OTFS modulation block.

Aspect 36: An apparatus for wireless communication at a device, comprising a processor; memory coupled with the processor; and instructions stored in the memory and executable by the processor to cause the apparatus to perform the method of one or more of Aspects 1-12.

Aspect 37: A device for wireless communication, comprising a memory and one or more processors coupled to the memory, the one or more processors configured to perform the method of one or more of Aspects 1-12.

Aspect 38: An apparatus for wireless communication, comprising at least one means for performing the method of one or more of Aspects 1-12.

Aspect 39: A non-transitory computer-readable medium storing code for wireless communication, the code comprising instructions executable by a processor to perform the method of one or more of Aspects 1-12.

Aspect 40: A non-transitory computer-readable medium storing a set of instructions for wireless communication, the set of instructions comprising one or more instructions that, when executed by one or more processors of a device, cause the device to perform the method of one or more of Aspects 1-12.

Aspect 41: An apparatus for wireless communication at a device, comprising a processor; memory coupled with the processor; and instructions stored in the memory and executable by the processor to cause the apparatus to perform the method of one or more of Aspects 13-23.

Aspect 42: A device for wireless communication, comprising a memory and one or more processors coupled to the memory, the one or more processors configured to perform the method of one or more of Aspects 13-23.

Aspect 43: An apparatus for wireless communication, comprising at least one means for performing the method of one or more of Aspects 13-23.

Aspect 44: A non-transitory computer-readable medium storing code for wireless communication, the code comprising instructions executable by a processor to perform the method of one or more of Aspects 13-23.

Aspect 45: A non-transitory computer-readable medium storing a set of instructions for wireless communication, the set of instructions comprising one or more instructions that, when executed by one or more processors of a device, cause the device to perform the method of one or more of Aspects 13-23.

Aspect 46: An apparatus for wireless communication at a device, comprising a processor; memory coupled with the processor; and instructions stored in the memory and executable by the processor to cause the apparatus to perform the method of one or more of Aspects 24-30.

Aspect 47: A device for wireless communication, comprising a memory and one or more processors coupled to the memory, the one or more processors configured to perform the method of one or more of Aspects 24-30.

Aspect 48: An apparatus for wireless communication, comprising at least one means for performing the method of one or more of Aspects 24-30.

Aspect 49: A non-transitory computer-readable medium storing code for wireless communication, the code comprising instructions executable by a processor to perform the method of one or more of Aspects 24-30.

Aspect 50: A non-transitory computer-readable medium storing a set of instructions for wireless communication, the set of instructions comprising one or more instructions that, when executed by one or more processors of a device, cause the device to perform the method of one or more of Aspects 24-30.

Aspect 51: An apparatus for wireless communication at a device, comprising a processor; memory coupled with the processor; and instructions stored in the memory and executable by the processor to cause the apparatus to perform the method of one or more of Aspects 31-35.

Aspect 52: A device for wireless communication, comprising a memory and one or more processors coupled to the memory, the one or more processors configured to perform the method of one or more of Aspects 31-35.

Aspect 53: An apparatus for wireless communication, comprising at least one means for performing the method of one or more of Aspects 31-35.

Aspect 54: A non-transitory computer-readable medium storing code for wireless communication, the code comprising instructions executable by a processor to perform the method of one or more of Aspects 31-35.

Aspect 55: A non-transitory computer-readable medium storing a set of instructions for wireless communication, the set of instructions comprising one or more instructions that, when executed by one or more processors of a device, cause the device to perform the method of one or more of Aspects 31-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, a configuration of a control region in a delay-Doppler domain;
receive, from the base station, a physical downlink control channel (PDCCH) communication with orthogonal time frequency space (OTFS) precoding; and
decode the PDCCH communication with OTFS precoding based at least in part on the configuration of the control region in the delay-Doppler domain.

2. The UE of claim 1, wherein the one or more processors, to decode the PDCCH communication with OTFS precoding, are configured to:
apply OTFS decoding to the PDCCH communication with OTFS precoding, resulting in an information block in the delay-Doppler domain; and
decode the PDCCH communication based at least in part on the configuration of the control region, wherein the configuration of the control region indicates a set of allocated delay-Doppler samples for the control region in the information block, and wherein the PDCCH communication is included in one or more delay-Doppler samples in the set of allocated delay-Doppler samples.

3. The UE of claim 2, wherein the configuration of the control region includes a first bitmap that indicates a delay domain resource allocation for the set of allocated delay-Doppler samples, and wherein the first bitmap includes a first plurality of bits, and each bit of the first plurality of bits indicates whether a corresponding group of consecutive samples in the delay domain is included in the delay domain resource allocation for the set of allocated delay-Doppler samples.

4. The UE of claim 3, wherein the configuration indicates a number of consecutive samples in a Doppler domain for a Doppler domain resource allocation for the set of allocated delay-Doppler samples.

5. The UE of claim 4, wherein the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

6. The UE of claim 3, wherein the configuration of the control region includes a second bitmap that indicates a Doppler domain resource allocation for the set of allocated delay-Doppler samples, and wherein the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

7. The UE of claim 6, wherein the one or more delay-Doppler samples, in which the PDCCH communication is included, comprise all of the Doppler domain resource allocation for the set of allocated delay-Doppler samples.

8. The UE of claim 6, wherein the one or more delay-Doppler samples, in which the PDCCH communication is included, comprise a subset of the Doppler domain resource allocation for the set of allocated delay-Doppler samples.

9. The UE of claim 2, wherein the PDCCH communication with OTFS precoding includes PDCCH data and a PDCCH demodulation reference signal (DMRS), and wherein the configuration of the control region indicates an allocation of the PDCCH DMRS on all or a subset of delay-Doppler samples in the set of allocated delay-Doppler samples.

10. The UE of claim 2, wherein the PDCCH communication with PDCCH precoding includes scheduling information for a physical downlink shared channel (PDSCH) communication, wherein the PDSCH communication is jointly modulated with the PDCCH communication in the information block.

11. The UE of claim 10, wherein the one or more processors are further configured to:
decode the PDSCH communication jointly modulated with the PDCCH communication in the information block based at least in part on the scheduling information.

12. The UE of claim 2, wherein the information block includes multiple repetitions of the PDCCH communication with OTFS precoding.

13. A base station for wireless communication, comprising:
a memory; and
one or more processors, coupled to the memory, configured to:
transmit, to a user equipment (UE), a configuration of a control region in a delay-Doppler domain;
apply orthogonal time frequency space (OTFS) precoding to a physical downlink control channel (PDCCH) communication included in the control region in the delay-Doppler domain; and
transmit, to the UE, the PDCCH communication with OTFS precoding.

14. The base station of claim 13, wherein the one or more processors, to decode the PDCCH communication with OTFS precoding, are configured to:
apply OTFS precoding to an information block in the delay-Doppler domain, wherein the configuration of the control region indicates a set of allocated delay-Doppler samples for the control region in the information block, and wherein the PDCCH communication is included in one or more delay-Doppler samples in the set of allocated delay-Doppler samples.

15. The base station of claim 14, wherein the configuration of the control region includes a first bitmap that indicates a delay domain resource allocation for the set of allocated delay-Doppler samples, and wherein the first bitmap includes a first plurality of bits, and each bit of the first plurality of bits indicates whether a corresponding group of consecutive samples in the delay domain is included in the delay domain resource allocation for the set of allocated delay-Doppler samples.

16. The base station of claim 15, wherein the configuration indicates a number of consecutive samples in a Doppler domain for a Doppler domain resource allocation for the set of allocated delay-Doppler samples.

17. The base station of claim 16, wherein the one or more delay-Doppler samples, in which the PDCCH communication is included, comprise all of the Doppler domain resource allocation for the set of allocated delay-Doppler samples and at least a subset of the delay domain resource allocation for the set of allocated delay-Doppler samples.

18. The base station of claim 15, wherein the configuration of the control region includes a second bitmap that indicates a Doppler domain resource allocation for the set of allocated delay-Doppler samples, and wherein the second bitmap includes a second plurality of bits, and each bit of the second plurality of bits indicates whether a corresponding grouping of one or more consecutive samples in the Doppler domain is included in the Doppler domain resource allocation for the set of allocated delay-Doppler samples.

19. The base station of claim 18, wherein the one or more delay-Doppler samples, in which the PDCCH communication is included, comprise all of the Doppler domain resource allocation for the set of allocated delay-Doppler samples.

20. The base station of claim 18, wherein the one or more delay-Doppler samples, in which the PDCCH communication is included, comprise a subset of the Doppler domain resource allocation for the set of allocated delay-Doppler samples.

21. A UE for wireless communication, comprising:
a memory; and
one or more processors, coupled to the memory, configured to:
receive, from a base station, a first stage physical downlink control channel (PDCCH) communication without orthogonal time frequency space (OTFS) precoding, wherein the first stage PDCCH communication indicates whether a downlink communication with OTFS precoding is scheduled in an OTFS modulation block; and
selectively buffer or not buffer time domain samples associated with the OTFS modulation block based at least in part on the first stage PDCCH communication.

22. The UE of claim 21, wherein the one or more processors, to selectively buffer or not buffer the time domain samples associated with the OTFS modulation block, are configured to:
buffer the time domain samples associated with the OTFS modulation block in connection with the first stage PDCCH communication indicating that the downlink communication with OTFS precoding is scheduled in the OTFS modulation block.

23. The UE of claim 22, wherein the one or more processors are further configured to:
receive a second stage PDCCH communication with OTFS precoding in the time domain samples associated with the OTFS modulation block, wherein the second stage PDCCH communication includes scheduling information for the downlink communication with OTFS precoding scheduled in the OTFS modulation block.

24. The UE of claim 23, wherein the one or more processors are further configured to:
decode the downlink communication with OTFS precoding from the time domain samples associated with the OTFS modulation block based at least in part on the scheduling information included in the second stage PDCCH communication.

25. The UE of claim 21, wherein the one or more processors, to selectively buffer or not buffer the time domain samples associated with the OTFS modulation block, are configured to:
select not to buffer the time domain samples associated with the OTFS modulation block based at least in part on the first stage PDCCH communication indicating that no downlink communication with OTFS precoding is scheduled in the OTFS modulation block.

26. The UE of claim 25, wherein the one or more processors are further configured to:
enter a sleep mode for a duration associated with the OTFS modulation block based at least in part on the first stage PDCCH communication indicating that no downlink communication with OTFS precoding is scheduled in the OTFS modulation block.

27. A base station for wireless communication, comprising:
a memory; and
one or more processors, coupled to the memory, configured to:
transmit, to a user equipment (UE), a first stage physical downlink control channel (PDCCH) communication without orthogonal time frequency space (OTFS) precoding, wherein the first stage PDCCH communication indicates whether a downlink communication with OTFS precoding is scheduled for the UE in an OTFS modulation block.

28. The base station of claim 27, wherein the first stage PDCCH communication indicates that the downlink communication with OTFS precoding is scheduled for the UE in the OTFS modulation block.

29. The base station of claim 28, wherein the one or more processors are further configured to:
transmit, to the UE, a second stage PDCCH communication with OTFS precoding, wherein the second stage PDCCH communication includes scheduling information for the downlink communication with OTFS precoding scheduled in the OTFS modulation block, wherein the second stage PDCCH communication with OTFS is included in the OTFS modulation block.

30. The base station of claim 27, wherein the first stage PDCCH communication indicates that no downlink communication with OTFS precoding is scheduled for the UE in the OTFS modulation block.
